(19) United States
(12) Patent Application Publication
(10) Pub. No.: US 2026/0311140 A1
(43) Pub. Date: Oct. 8, 2026

(54) MAINTENANCE TARGETING GENERATOR AND MODEL FEEDBACK COMPUTING SYSTEM AND RELATED METHODS

(71) Applicant: State Farm Mutual Automobile Insurance Company, Bloomington, IL (US)

(72) Inventor: Sean Hickey, Garland, TX (US)

(21) Appl. No.: 19/555,107

(22) Filed: Mar. 3, 2026

Related U.S. Application Data
(60) Provisional application No. 63/809,802, filed on May 21, 2025.
(60) Provisional application No. 63/782,266, filed on Apr. 2, 2025.

(51) Int. Cl. G06Q 10/20; G06N 20/00; G06T 19/00; G06V 20/20; G06V 20/70; H04L 51/02

(52) U.S. Cl. CPC G06Q 10/20; G06N 20/00; G06T 19/006; G06V 20/20; G06V 20/70; H04L 51/02

(57) ABSTRACT

A computer system is provided. The computer system may be configured to generate maintenance targetings and model feedback based at least in part upon sample maintenance data and user requests including subject building components and inquiries related thereto.

### CROSS-REFERENCE TO RELATED APPLICATIONS

This application claims the benefit of priority to U.S. Provisional Patent Application No. 63/809,802, filed on May 21, 2025, and to U.S. Provisional Patent Application No. 63/782,266, filed on Apr. 2, 2025, the contents and disclosure of each of which are hereby incorporated by reference herein.

### FIELD OF THE DISCLOSURE

The field of the disclosure relates generally to maintenance targeting, and more specifically, to generating and modelling maintenance targeting for building components of a building or other structure.

### BACKGROUND

Homes and other buildings generally require maintenance and repair. Computing devices may be used to retrieve and display information about maintenance and repair. However, because each home is unique, the types of general information that may be retrieved using computers (e.g., through Internet searches) may not apply to specific homes. For example, locations of specific items and other components of the home or building, and how to fix, maintain, or otherwise care for these components, may be difficult to ascertain for certain users.

Conventional techniques may include additional inadequacies, ineffectiveness, encumbrances, inefficiencies, and other drawbacks as well.

### BRIEF DESCRIPTION

In general, the present embodiments may relate to, inter alia, computer systems and computer-based methods that determine a component or item needing repair or service and, based thereupon, determine an appropriate action to take, including providing contextually relevant guidance or instructions (such as visual or audible guidance or instructions) to a user to perform the action. More specifically, computer systems and computer-implemented methods for generating and modelling maintenance targeting for building components of a building or other structure may be provided. For example, the systems and methods described herein may be configured to ingest a large initial data set of sample building component maintenance data and, in some instances, train one or more machine-learning models to recognize patterns, connections, and trends between characteristics of building components and their related maintenance. The systems and methods may identify building components or parts thereof to be repaired or maintained, determine potential maintenance targeting (e.g., mitigating or remedial actions), and present maintenance targeting to users as instructional guidance for the user to enact the repairs or maintenance.

Moreover, the systems and methods may present the maintenance targeting in a variety of useful formats, such as via links to existing documentation (e.g., existing text or video sources), natural language instruction drawn from existing documentation and/or generated using one or more generative artificial intelligence (GEN-AI) techniques, GEN-AI image or video, virtual reality (VR) (or eXtended Reality) guidance or walkthroughs of generic or personalized instructions, and/or augmented reality (AR) overlays over a real-time image and/or video stream captured at a user computing device. The systems and methods seek and ingest feedback from the user regarding the efficacy of the presented maintenance targeting to proactively or responsively address their building component issue, as well as the utility or favorability of the presentation format, and incorporates this feedback to re-train the trained model(s) to improve the prediction capability and responsiveness of the re-trained model(s). In the exemplary embodiment, users access the functionality of the computer system via at least one downloaded and executed software application (“app”) on their user computing device and, in at least some instances, users interact with the system to input inquiries and receive maintenance targeting, including steps or tasks to be performed, via a chatbot (e.g., an AI-enabled chatbot). The system may include less, or alternate functionality, including that discussed elsewhere herein.

In one aspect, a computer system may be provided. The system may include one or more local or remote processors, servers, sensors, transceivers, mobile devices, wearables, smart watches, smart contact lenses, voice bots, chatbots, ChatGPT bots, augmented reality glasses, virtual reality headsets, mixed or extended reality headsets or glasses, and other electronic or electrical components, which may be in wired or wireless communication with one another. For example, in one instance, the computer system may be programmed to: (a) ingest sample maintenance data for a plurality of sample homes, the sample maintenance data including sample maintenance histories corresponding to each of the plurality of sample homes and sample building components thereof; (b) receive, from a user computing device, a request message including an inquiry related to a subject building component; (c) determine a characteristic of the subject building component; (d) identify a subject maintenance targeting based at least in part upon a subset of the sample maintenance data associated with sample building components having the same or a related characteristic; (e) process an image or video stream captured at the user computing device, the image or video stream at least partially capturing the subject building component; and/or (f) overlay one or more maintenance labels onto the image or video stream in real-time in a location related to the at least partially captured subject building component, the maintenance label identifying the subject maintenance target. The computer system may include additional, less, or alternate functionality, including that discussed elsewhere herein.

In another aspect, a maintenance targeting generator including at least one processor in communication with at least one memory device may be provided. The at least one processor may be configured to: (a) ingest sample maintenance data for a plurality of sample homes, the sample maintenance data including sample maintenance histories corresponding to each of the plurality of sample homes and sample building components thereof; (b) receive, from a user computing device, a request message including an inquiry related to a subject building component; (c) determine a characteristic of the subject building component; (d) identify a subject maintenance targeting based at least in part upon a subset of the sample maintenance data associated with sample building components having the same or a related characteristic; (e) process an image or video stream captured at the user computing device, the image or video stream at least partially capturing the subject building component; and/or (f) overlay one or more maintenance labels onto the image or video stream in real-time in a location related to the at least partially captured subject building component, the maintenance label identifying the subject maintenance target. The computing device may include additional, less, or alternate functionality, including that discussed elsewhere herein.

In a further aspect, a computer-implemented method for generating maintenance targeting in response to inquiries may be provided. The method may be implemented using a computing system including at least one processor in communication with at least one memory device. The method may include: (a) ingesting sample maintenance data for a plurality of sample homes, the sample maintenance data including sample maintenance histories corresponding to each of the plurality of sample homes and sample building components thereof; (b) receiving, from a user computing device, a request message including an inquiry related to a subject building component; (c) determining a characteristic of the subject building component; (d) identifying a subject maintenance targeting based at least in part upon a subset of the sample maintenance data associated with sample building components having the same or a related characteristic; (e) processing an image or video stream captured at the user computing device, the image or video stream at least partially capturing the subject building component; and/or (f) overlaying one or more maintenance labels onto the image or video stream in real-time in a location related to the at least partially captured subject building component, the maintenance label identifying the subject maintenance target. The method may include additional, fewer, or alternative steps, including those discussed elsewhere herein.

In yet another aspect, at least one non-transitory computer-readable storage medium having stored thereon computer-executable instructions may be provided. When executed by at least one processor, the computer-executable instructions may cause the at least one processor to: (a) ingest sample maintenance data for a plurality of sample homes, the sample maintenance data including sample maintenance histories corresponding to each of the plurality of sample homes and sample building components thereof; (b) receive, from a user computing device, a request message including an inquiry related to a subject building component; (c) determine a characteristic of the subject building component; (d) identify a subject maintenance targeting based at least in part upon a subset of the sample maintenance data associated with sample building components having the same or a related characteristic; (e) process an image or video stream captured at the user computing device, the image or video stream at least partially capturing the subject building component; and/or (f) overlay one or more maintenance labels onto the image or video stream in real-time in a location related to the at least partially captured subject building component, the maintenance label identifying the subject maintenance target. The instructions may cause additional, less, or alternative functionality, including that discussed elsewhere herein.

In one aspect, a maintenance model feedback computing device may be provided. The computing device may include at least one memory device and at least one processor. The at least one processor may be programmed to: (a) ingest sample maintenance data for a plurality of sample homes, the sample maintenance data including sample maintenance histories corresponding to each of the plurality of sample homes and sample building components thereof; (b) train a machine-learning model using the sample maintenance data as an initial training data set; (c) receive, from a user computing device, a request message including an inquiry related to a subject building component; (d) execute the trained machine-learning model based upon one or more data elements included in the request message to receive a model output of at least one likely maintenance targeting responsive to the inquiry; (e) present the at least one likely maintenance targeting; (f) receive feedback, from the user computing device, associated with an efficacy of the at least one likely maintenance targeting; and/or (g) re-train the trained machine-learning model using the received feedback. The computing device may include additional, less, or alternate functionality, including that discussed elsewhere herein.

In a further aspect, a computer-implemented method for maintenance model feedback may be provided. The method may be implemented using a computing system including at least one processor in communication with at least one memory device. The method may include: (a) ingesting sample maintenance data for a plurality of sample homes, the sample maintenance data including sample maintenance histories corresponding to each of the plurality of sample homes and sample building components thereof; (b) training a machine-learning model using the sample maintenance data as an initial training data set; (c) receiving, from a user computing device, a request message including an inquiry related to a subject building component; (d) executing the trained machine-learning model based upon one or more data elements included in the request message to receive a model output of at least one likely maintenance targeting responsive to the inquiry; (e) presenting the at least one likely maintenance targeting; (f) receiving feedback, from the user computing device, associated with an efficacy of the at least one likely maintenance targeting; and/or (g) re-training the trained machine-learning model using the received feedback. The method may include additional, fewer, or alternative steps, including those discussed elsewhere herein.

In yet another aspect, at least one non-transitory computer-readable storage medium having stored thereon computer-executable instructions may be provided. When executed by at least one processor, the computer-executable instructions may cause the at least one processor to: (a) ingest sample maintenance data for a plurality of sample homes, the sample maintenance data including sample maintenance histories corresponding to each of the plurality of sample homes and sample building components thereof; (b) train a machine-learning model using the sample maintenance data as an initial training data set; (c) receive, from a user computing device, a request message including an inquiry related to a subject building component; (d) execute the trained machine-learning model based upon one or more data elements included in the request message to receive a model output of at least one likely maintenance targeting responsive to the inquiry; (e) present the at least one likely maintenance targeting; (f) receive feedback, from the user computing device, associated with an efficacy of the at least one likely maintenance targeting; and/or (g) re-train the trained machine-learning model using the received feedback. The instructions may cause additional, less, or alternative functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple figures are designated with consistent reference numerals.

There are shown in the drawings arrangements which are presently discussed herein. However, it should be understood that the present embodiments are not limited to the precise arrangements and/or instrumentalities shown herein.

FIG. 1 depicts an exemplary computer system in accordance with an exemplary embodiment of the present disclosure.

FIG. 2 depicts an exemplary client computing device that may be used with the exemplary computer system illustrated in FIG. 1.

FIG. 3 depicts an exemplary server system that may be used with the exemplary computer system illustrated in FIG. 1.

FIG. 4 depicts an exemplary user interface that may be displayed to a user of a client computing device by the exemplary computer system illustrated in FIG. 1.

FIGS. 5A-5C depict a sequence of user interfaces that may be displayed to a user of a client computing device by the exemplary computer system illustrated in FIG. 1.

FIG. 6 depicts an exemplary real-time augmented reality (AR) overlay that may be displayed to a user of a client computing device by the exemplary computer system illustrated in FIG. 1.

FIG. 7 depicts a virtual reality (VR) scene that may be displayed to a user of a client computing device by the exemplary computer system illustrated in FIG. 1.

FIG. 8 illustrates an exemplary computer-implemented method for generating a maintenance target for a building component of a building, for overlay on a real-time incoming visual data stream from a user computing device.

FIG. 9 illustrates an exemplary computer-implemented method for incorporating feedback associated with maintenance target output formatting and efficacy for re-training at least one machine-learned model.

FIG. 10 depicts another exemplary real-time AR overlay that may be displayed to a user of a client computing device by the exemplary computer system illustrated in FIG. 1.

FIG. 11 depicts a further exemplary real-time AR overlay that may be displayed to a user of a client computing device by the exemplary computer system illustrated in FIG. 1.

FIG. 12 depicts another exemplary real-time AR overlay that may be displayed to a user of a client computing device by the exemplary computer system illustrated in FIG. 1.

FIG. 13 depicts a still further exemplary real-time AR overlay that may be displayed to a user of a client computing device by the exemplary computer system illustrated in FIG. 1.

FIGS. 14-16 depict an exemplary VR instructional scene that may be displayed to a user of a client computing device by the exemplary computer system illustrated in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, computer systems and computer-based methods for generating and modelling maintenance targeting for building components of a building or other structure. For example, the systems and methods described herein may be configured to ingest a large initial data set of sample building component maintenance data and, in some instances, train one or more machine-learning models to recognize patterns, connections, and trends between characteristics of building components and their related maintenance. The systems and methods may identify building components or parts thereof to be repaired or maintained, determine potential maintenance targeting (e.g., mitigating or remedial actions), and present maintenance targeting to users as instructional guidance for the user to enact the repairs or maintenance.

Moreover, the systems and methods may present the maintenance targeting in a variety of useful formats, such as via links to existing documentation (e.g., existing text or video sources), natural language instruction drawn from existing documentation and/or generated using one or more generative artificial intelligence (GEN-AI) techniques, GEN-AI image or video, virtual reality (VR) guidance or walkthroughs of generic or personalized instructions, and/or augmented reality (AR) overlays over a real-time image and/or video stream captured at a user computing device. The systems and methods seek and ingest feedback from the user regarding the efficacy of the presented maintenance targeting to proactively or responsively address their building component issue, as well as the utility or favorability of the presentation format, and incorporates this feedback to re-train the trained model(s) to improve the prediction capability and responsiveness of the re-trained model(s). In the exemplary embodiment, users access the functionality of the computer system via at least one downloaded and executed software application (“app”) on their user computing device and, in at least some instances, users interact with the system to input inquiries and receive maintenance targeting, including steps or tasks to be performed, via a chatbot (e.g., an AI-enabled chatbot). The system may include less, or alternate functionality, including that discussed elsewhere herein.

In exemplary embodiments, the computing system described herein may be referred to as a maintenance targeting generator and model feedback computing system. This computing system may include a centralized server computing device configured to perform actions or methods describes herein. In some instances, therefore, the server computing device may sometimes be referred to as a maintenance targeting generator and model feedback computing device, a maintenance targeting generator, a model feedback computing device, and/or a maintenance model feedback computing device.

As described further herein, the maintenance targeting generator may be configured to identify and/or generate at least one maintenance targeting associated with one or more building components of a building. “Buildings” may include fixed structures, such as homes, commercial or industrial buildings, schools, storage facilities, out-buildings, and the like. However, it should be understood that although “building components” are described and used in the exemplary language herein, the disclosure of the present application is not limited to fixed structures but may also apply to non-fixed structures including mobile homes, recreational vehicles (RVs), automobiles, watercraft, aircraft, temporary structures, etc. Moreover, the present disclosure may also apply to building components without a fixed or permanent location, including portable components, components reinstalled at different locations, etc.

Buildings may have building data associated therewith. Building data may include, for example, building characteristics or “biographical” information related to a building, such as age, location, building materials, maintenance history, insurance claim history, and the like. Building data may further include a listing or other identification of building components, as described further herein, that are located in or associated with the building. In some instances, building data may include a layout of the building (e.g., a floorplan and/or a three dimensional (or two dimensional or four-dimensional) model, blueprints, floor plans, CAD files, images, LIDAR scans, data generated by sensors and/or smart devices, etc., a list of building components or other items located in the building (e.g., structural or utility-related components, appliances, tools, supplies of materials, or other items), and/or other data that may be derived from this input data (e.g., using AI and/or machine learning techniques).

As used herein, “building components” may refer generally to individual objects, parts, or systems present within or in physical association with a building. For instance, building components may include structural parts of a building (e.g., a joist or column); a fixed non-structural part of a building (e.g., a flooring material, a countertop, piping); an object within a building such as an appliance, a sensor, a smart device, an alarm, a wireless router, a piece of furniture, etc.; and/or systems of a building (and/or parts thereof), such as a heating, ventilation, and air conditioning (HVAC) system, a water supply, a utility system (e.g., an electric or gas system), a solar panel system, and the like; and/or other such objects. Building components may have characteristics associated therewith. Characteristics may by relatively fixed or unchangeable, such as, but not limited to, age, model number, model year, presence/absence of a feature, and/or capability or functionality (e.g., “Wi-Fi enabled,” or “programmable”). Characteristics may additionally be “instance specific,” such as location (e.g., a geolocation and/or a relative location within a building), position, orientation, installation type, operating schedule, time in operation, maintenance history, repair history, and the like. Characteristic may further include a status of the building component. The component status may be a score or other numerical indicator of the component’s state or “health” (e.g., a number on a scale of 1-10). The component status may be a binary indicator that represents “good” (e.g., not needing repair or maintenance) or “not good” (e.g., needing repair or maintenance).

In the exemplary embodiment, the maintenance targeting generator may be configured to ingest sample maintenance data. In some instances, the maintenance targeting generator may include or have access to one or more databases for ingesting sample maintenance data including storing the sample maintenance data. One such database, a sample database, may be built or populated by the maintenance targeting generator and/or by one or more other entities (e.g., users, third-party entities such as component manufacturers, insurance companies, etc.). The sample maintenance data may include sample maintenance histories corresponding to each of a plurality of sample homes and building components thereof, over a historical period of time, and/or maintenance recommendations made by a manufacturer of the item or an industry organization or other organization issuing recommended maintenance plans, which may include recommended maintenance schedules (e.g., a recommended periodicity of changing an air filter). The maintenance histories may include sample building data and/or sample building component data (e.g., characteristics). Data within the sample database may be stored and indexed by a building identifier or a building component identifier, or by any other data element.

The sample maintenance data may be received in various formats for storage at the sample database, such as text-based data, images, video, sound data, etc. The maintenance targeting generator may re-format, synthesize, or otherwise process data for storage. At least some of the sample maintenance data may be provided directly or indirectly to the maintenance targeting generator by users, such as homeowners, property owners, landlords, property managers, and the like. Data may be collected by prompting these users for information and receiving the information as responses to such prompts. Additionally or alternatively, the maintenance targeting generator may, with consent of the user, receive sample building data inputs that are collected by smart devices or other network-connected devices within buildings. Additionally or alternatively, the maintenance target generator may access or receive sample building data from a third-party data store, such as an insurance claims history. In some instances, the sample maintenance data may also include information associated with building components that are not specific to one building, including data collected from internet sources or other available sources. This information may include, for example, images, text-based data (e.g., manuals or instructions), videos, and the like.

At least some of the building data and/or building component data may additionally or alternatively be stored in an active user database. Data related to the buildings of the users that may access the functionality of the maintenance targeting generator may be stored in the active user database, such that analyses related to recommendations or other actions on behalf of active users may be performed without parsing the sample database. In some embodiments, the data related to active users may be stored in the sample database with an appended data element that identifies related entries as associated with active users.

In the exemplary embodiment, the maintenance targeting generator may be further configured to ingest the sample maintenance data including compiling at least a subset of the sample maintenance data as an initial training data set for training one or more machine-learning models. In some instances, all available sample maintenance data may be compiled as the initial training data set. In other instances, the maintenance targeting generator may parse the sample maintenance data to include or exclude certain subset(s) of the sample maintenance data. As one example, the maintenance targeting generator may filter out “stale” data that was collected or stored before a certain date. In some embodiments, the maintenance targeting generator may parse the sample maintenance data using one or more database queries specifically constructed to exclude or include the specific desired data. In other embodiments, such as where the sample maintenance data is stored non-centrally across two or more data sources, the maintenance targeting generator may parse the sample maintenance data by requesting or accessing specific data source(s) and/or transmitting one or more specifically structured queries to the data source(s).

In the exemplary embodiment, the machine-learning model is trained on the initial training data set to, broadly, recognize patterns in the sample maintenance data. These relationships may be, for example, correlations between data elements or parameters that were previously unrecognized. These patterns may include, for example but without limitation, relationships between building components and repair/maintenance tasks, component characteristics and repair/maintenance tasks, frequent sequences or patterns of repair/maintenance tasks relative to other tasks, building data and building components, building data and component characteristics, building components and component characteristics, and the like. In some instances, the trained machine-learning model recognizes these patterns relative to building component maintenance history. Some examples of modeled or recognized component maintenance history include, but are in no way limited to, the most frequently repaired building component in a water supply system of a home, the most common maintenance performed on a basement sump pump, the longest lasting appliance in a certain class (e.g., refrigerator), and the like.

In this way, and as described further herein, the trained machine-learning model is trained to receive, as input(s), data related to a subject building component, for example, as part of request message(s). The input data may identify a building component and a related inquiry, as well as one or more characteristics of the building component (which may, in some instances, include a status of the building component). Additionally or alternatively, the maintenance targeting generator may derive the building component, characteristics, and/or status from other data in the request message or otherwise available.

Using these data elements (or more, fewer, or alternative data elements), the trained machine-learning model is configured to output at least one potential, likely, or common (e.g., frequent) maintenance targeting associated with the building component identified in the request message. A “maintenance targeting,” as used herein, refers to an action or intervention (e.g., repair or maintenance related step(s)) to be taken that is related to a building component that is the subject of a request message (that is, a “subject building component”) and/or a part thereof. One example maintenance targeting may include acting upon a water shut-off valve of a water supply system. In some instances, a maintenance targeting may be an action that is not in and of itself an intervention, such as the identification or labelling of a building component or a part thereof. As described further herein, the maintenance targeting generator presents (e.g., displays) at least one maintenance targeting to a requesting user (e.g., in response to an inquiry related to a subject building component). The maintenance targeting may include or be associated with one or more labels or other contextual information that provides instruction or guidance to a user to understand, perform, and/or complete the repair or maintenance actions or steps.

### User Interface

In the exemplary embodiment, the maintenance targeting generator is communicatively coupled to at least one user computing device via a communication network and/or interface that enables the maintenance targeting generator to receive data and/or messages from the user computing device and transmit data and/or messages to the user computing device. For example, the user computing devices may be a mobile device configured to execute a mobile application (“app”) that is downloaded on the user computing device and enables the user computing device to access the functionality of the maintenance targeting generator, although any functionality related to the app as described herein is equally applicable to a browser website. The maintenance targeting generator may “host” the app or otherwise be associated with hosting infrastructure that facilitates the app functionality. The maintenance targeting generator may generate data, content, and/or instructions that cause the user computing device to display a user interface when the app is executed on the user computing device, the user interface enabling the transmission of data between the user computing device (and/or a user thereof) and the maintenance targeting generator. The user interface may display various interactive features, including selectable options for a user of the user computing device to provide data inputs to maintenance targeting generator and/or to receive data outputs from the maintenance targeting generator.

One such interactive feature may include, for example, a selectable option for a user of the user computing device to input information related to one or more buildings or building components. For example, the user may build a “profile” of their home by identifying various building components and associated characteristics (e.g., via text, image, video, etc.). The user may input information related to their home (or another building), such as a floor plan, three-dimensional model, images or video walkthrough, etc.

In the exemplary embodiment, another interactive feature of the app user interface is a selectable option to submit a request message to the maintenance targeting generator. The maintenance targeting generator may be configured to receive, from a user computing device (e.g., via the communicative coupling provided by the app), request messages. In some embodiments, the maintenance targeting generator may generate and cause display of the user interface to include a prompt for the user to submit their request message. The request message may identify a building component and an inquiry relating to the building component (e.g., a status of the building component, a reported issue with the building component, and/or a question about the building component). The building component that is the subject of the inquiry is referred to herein as a “subject building component.” As used herein, “inquiry” refers to data element or message component that defines a request for certain information that may be identified from within the inquiry itself or determined contextually by the computing system (e.g., using other data from the request message or by other means).

The request message may further include additional data, such as subject building component characteristics that are input or otherwise positively or intentionally provided by the user within the context of the inquiry, an image or video stream or other images or videos captured by a camera and/or other sensors of the user computing device, and/or other data relevant to providing information about the subject building component or associated building. The request message may additionally or alternatively include metadata associated with the user computing device, such as positional data relating to a position of the user computing device (e.g., global positioning system (GPS), accelerometer, and/or gyroscope data indicating a position and/or orientation of the user computing device).

In the exemplary embodiment, the user computing device is configured to display any information, such as responses to inquiries, from the maintenance targeting generator within the user interface of the app. In some instances, the maintenance targeting generator causes display of responses to inquiries within a same page or screen of the app, such that the user does not need to perform any navigation operations to view, hear, or otherwise receive the information. In many exemplary embodiments, the actions of the maintenance targeting generator, including responding to inquiries, are performed in real-time or substantially in real time, such as within seconds or less than a minute, such that reducing the need for navigation to another page is beneficial to the user.

In some instances, the maintenance targeting generator may be configured to display information other than a response to an inquiry, such as a proactive recommendation. The maintenance targeting generator may cause display of this information within a section of the app that contextually relates to the request submission section, such as a messaging interface, to enhance intuitive use of and interaction with the app. Alternatively, the user interface may include alternative interactive features and corresponding pages to display such information (e.g., a “Recommendations” page). The maintenance targeting generator may also cause display of one or more feedback prompts, screens, and/or sections of the app, enabling and encouraging user feedback related to the outputs generated and presented by the maintenance targeting generator.

In some embodiments, at least some of the user interaction within the user interface of the app is facilitated by and/or conducted with a chatbot feature, an access to which may be provided by the maintenance targeting generator. For example, chatbots and/or GEN-AI (e.g., generative pre-trained transformer (GPT)-based) programs may be used to introduce a user to one or more features of the app, generate a home profile, and/or prompt the user to submit a request message. Accordingly, the request message may be submitted in a variety of different formats interpretable by the chatbots and/or AI applications, such as natural language (e.g., text or speech), videos, images, sound recordings, and/or any other inputs that may be used. Likewise, in some instances, the chatbot and/or GEN-AI programs may be used to generate and/or display information to be included in a response to an inquiry. Accordingly, the responses may be presented in a variety of different formats, such as natural language (e.g., text or speech), links, image- or video-based (which may be retrieved or may be generated by the chatbot/GEN-AI and/or which may include VR content), real-time AR overlays, or any other outputs to be presented within the user interface, as described in greater detail herein.

### Generating Responses to Request Messages

In the exemplary embodiment, the maintenance targeting generator is configured to generate responses to received request message. As described above, such a request message may be input by a user using a user computing device and transmitting to the maintenance targeting generator. In some embodiments, the maintenance targeting generator may receive a request message from the user computing device and may parse request message to identify the inquiry and the building component that is the subject of the inquiry (the “subject building component”), at least one characteristic of the subject building component. The maintenance targeting generator may parse additional data from the request message, such as included characteristics of the subject building component, metadata associated with the user computing device, etc. Additionally or alternatively, the maintenance targeting generator may be configured to process data from the request message to derive information related to the subject building component (e.g., using image processing, text processing, AI, and/or machine-learning techniques) to identify, for example, other building components of the building and/or building component characteristics.

In the exemplary embodiment, the maintenance targeting generator may be configured to retrieve data in response to receiving the request message, for generating a response to the inquiry therein. As described herein, the maintenance targeting generator may be configured to execute various data processing techniques to identify at least one maintenance targeting that is related to the subject building component and responsive to the inquiry, based at least in part a subset of the sample maintenance data associated with building components having the same or a related characteristic as the subject building component. Each maintenance targeting may have data associated therewith, such as an estimated or assigned level of difficulty, estimated completion time, number or availability of tools needed, and the like.

In the exemplary embodiment, the maintenance targeting generator may execute a trained machine-learning model trained on the sample maintenance data as an initial training data set. The maintenance targeting generator may receive a model output of at least one potential or likely maintenance target responsive to the inquiry. The output maintenance targeting(s) represents a suggested intervention or an intervention or action most likely to address the inquiry or issue identified in the inquiry.

In at least some embodiments, the trained machine-learning model may output prompts for user input to collect additional data points that may strengthen or modify the output maintenance targeting(s). For example, the trained machine-learning model may recognize that the initial input is related to a sink (the subject building component), an input or derived characteristic of the sink is “broken” or “not operational,” and/or an inquiry relates to “fixing” the sink. The trained machine-learning model may further recognize, as a result of the training using the initial training data set, that multiple potential maintenance targetings have a same confidence or relevance level to be responsive to the inquiry, such as “open the water shut-off valve”, “close the water shut-off valve”, “tighten the nuts”, “check the drain seal”, “clean the spout aerator”, “replace the cartridge valve”, etc. Each such maintenance target may generally apply to “fix broken sink.” Therefore, the trained-machine learning model may output instructions to extract further information. The maintenance targeting generator, executing the trained machine-learning model, may receive the model output and, in response, generate one or more prompts that is/are presented to the user. Continuing with the above example, one prompt may include “Is the sink leaking?” The maintenance targeting generator may process any user response and determine whether to continue presenting prompts. Continuing with the above example, a further prompt may include “Is the faucet leaking?” The maintenance targeting generator may feed any user responses to the prompts back to the trained machine-learning model, which may output further prompt(s) and/or a maintenance targeting (e.g., once a sufficient confidence level or relevance level has been met). In some embodiments, the maintenance targeting generator may perform these processes (e.g., identifying a need for further inputs, presenting prompts, processing responses) without executing a machine-learning model.

Alternatively, the maintenance targeting generator may generate one or more database queries for filtering the sample maintenance data to the subset of the sample maintenance data, and query at least one database (e.g., the sample database) using the one or more database queries to retrieve the filtered subset of the sample maintenance data for further processing. The maintenance targeting generator may the identify a maintenance targeting responsive to the inquiry based at least in part upon a subset of the sample maintenance data associated with building components having the same or a related characteristic as the subject building component. In some embodiments, the maintenance targeting generator determines a plurality of maintenance targetings as a result of these analysis and orders potential maintenance targetings based on various factors, such as ease of performance, likelihood of success, least skill required, etc. As described further herein, as a user provides feedback related to a maintenance targeting presented by the maintenance targeting generator, the maintenance targeting generator may continue to identify or present other maintenance targetings.

Various maintenance targetings may be identified as a result of these processes. For example, the request message may identify (e.g., depict) a basement floor that has standing water thereon. As described herein, the request message may be input by the user as natural language text, one or more static images, a real-time video feed, an/or any other available format(s). The request message may further include an inquiry, such as a request for a solution to fix a sump pump (and/or, in some instances, clean the basement floor). The request message may identify the subject building component as the sump pump (and/or, in some instance, the basement floor). Where the user did not identify the subject building component, the maintenance targeting generator may parse information from the request message to determine the subject building component to be the sump pump (or the basement floor) and that the subject building component has a characteristic (a depth; a material; a geolocation or climate). The maintenance targeting generator may execute the above-described analyses of the sample maintenance data, and may determine one maintenance targeting is to troubleshoot or repair the sump pump.

As another example, the request message may identify (e.g., depict) a wireless router with a particular status indicator, such as two lights flashing quickly or one light having a determined color (e.g., red). As described herein, the request message may be input by the user as natural language text, one or more static images, a real-time video feed, an/or any other available format(s). The request message may further include an inquiry, such as a request for a solution to fix an issue with wireless Internet. Where the user did not identify the subject building component, the maintenance targeting generator may parse information from the request message to determine the subject building component to be the wireless router and that the subject building component has a characteristic (a model; an age). The maintenance targeting generator may execute the above-described analyses of the sample maintenance data, and may determine one maintenance targeting is to restart the wireless router, restart another component of the wireless Internet system (e.g., a whole-house modem) or to replace the wireless router. In some embodiments, these maintenance targetings may be presented to the user in the above sequence, when a preceding maintenance targeting is unsuccessful, based upon an ease of completion of the maintenance targetings and/or a historical rate of success of the maintenance targetings.

Based upon the maintenance targeting output from the trained machine-learning model and/or resulting from other analyses of the sample maintenance data, the maintenance targeting generator is configured to generate and format a response message to present the maintenance targeting(s) to the requesting user. The maintenance targeting may be presented to the user in the response message along with various data including the level of difficulty, tools required, estimated time to completion, etc. The maintenance targeting may be presented as one or more labels, instructions, guidance, or the like, to guide the user to perform and/or complete the maintenance targeting.

As described herein, responses may be presented in any available format or combination thereof. In some embodiments, users may submit request messages with natural language inquiries (e.g., via text and/or voice), based upon which the maintenance targeting generator may generate a response (e.g., including at least one maintenance targeting) to be presented within the user interface. This response may include a description of the maintenance target, which may include instructions. For example, if the subject building component is a leaking pipe and the maintenance targeting includes patching the pipe, the response generated by the maintenance targeting generator and presented within the user interface may include a natural language text- or audio-based statement such as “Let’s try to fix the leak,” and text-based instructions or a link to existing text- or video-based instructions. These interactions may be conducted within the context of a chatbot messaging interface accessible within the mobile app.

A selected format may be determined based upon a user preference or selection or input of a particular command or option (e.g., “provide text instructions,” “show me a YOUTUBE video,” “give me AR directions,” etc.). For example, the maintenance targeting generator may present a maintenance targeting as a text-based response based upon user selection of a text-based presentation/display format. The maintenance targeting generator may display a maintenance targeting as an overlay over a real-time image or video stream captured at the user computing device (e.g., by a camera thereof) based upon user selection of an AR presentation/display format. The maintenance targeting generator may display a maintenance targeting as a VR video based upon user selection of a VR presentation/display format.

In some instances, as described above, the maintenance targeting generator may receive the request message as an input to a chatbot displayed or active within the user interface of the app. Upon identifying a maintenance targeting for presentation, the maintenance targeting generator may display the chatbot including a prompt for a user of the user computing device to select the presentation format for the maintenance targeting generator to present the maintenance targeting.

Additionally or alternatively, such as where no preference or command is provided, the maintenance targeting generator may select a format based upon output from the trained machine-learning model, which may indicate the format that has received the most positive user feedback or that is most associated with a likelihood of success. Additionally or alternatively, the maintenance targeting generator may select a format based upon the format of the request message or inquiry that was sent by the user, or according to other criteria.

In some embodiments, the user interface may enable AR functionality. For example, the user computing device may include or be configured for communication with an AR and/or VR headset (e.g., an OCULUS QUEST or GOOGLE GLASS). In one example, the user computing device may be held so that a camera of the user computing device captures a live image or video stream. The maintenance targeting generator may receive the live (or real-time) image or video stream, process an image or video stream captured at the user computing device, the image or video stream at least partially capturing the subject building component, and generate an overlay including one or more maintenance labels representing the maintenance targeting. The overlay also includes instructions defining the location at which the maintenance labels are to be displayed, within the live image or video stream.

In some cases, for example, the maintenance targeting includes an intervention to be performed that is related to the subject building component. The maintenance targeting generator may generate the overlay including a graphical maintenance label conveying the intervention (e.g., arrows or directional markers, push/pull markers, icons, etc.). The maintenance targeting generator may generate the overlay to additionally or alternatively include text-based maintenance labels (and/or instructions) conveying the intervention.

Additionally or alternatively, the maintenance targeting is associated with a part of the subject building component. The maintenance targeting generator may generate the overlay including a text-based maintenance label identifying the part of the subject building component and at least one graphical maintenance label of the subject building component. The maintenance targeting generator may further generate the overlay further including one or more other text-based maintenance labels identifying a corresponding one or more other parts of the subject building component. The instructions control the locations of the one or more other text-based maintenance labels, such that the one or more other text-based labels do not overlap with the text-based maintenance label identifying the part of the subject building component, when the overlay is displayed within the live image or video stream.

The maintenance targeting generator may be configured to cause the user computing device to display the live image or video stream with the generated overlay, including the generated maintenance labels. The maintenance labels may be displayed as overlaid on the live image or video stream in a location related to the subject building component as captured in the image/video stream. For example, when viewed using the user computing device, the overlay may be positioned within the image stream to show the maintenance labels in locations according to the generated instructions. The overlay may be continually updated based upon a position of the user computing device, so that if the user computing device is moved, components of the image overlay may move within the image stream to retain their virtual position. The maintenance targeting generator may additionally generate a response that causes the user computing device to perform different actions, such as generating audible feedback (e.g., alarms and/or audible instructions) and/or haptic feedback (e.g., vibrations), based upon a position and/or orientation and/or other data (e.g., image data) received from the user computing device.

In another example, the user computing device may include or be configured for communication with an AR headset (e.g., an OCULUS QUEST or GOOGLE GLASS), which may display the overlay within the user’s field of view. In either example, the display may be continually updated, so that the overlaid maintenance labels correspond to an actual location of the identified subject building component or part(s) thereof, with respect to the camera and/or headset. In some embodiments, images captured by the user computing device and/or headset may be saved, enabling users to view the AR interface remotely or at a later time.

In some embodiments, the maintenance targeting generator may generate one or more VR representations of the subject building component and the identified maintenance targeting(s). For example, the VR representations may function as illustrative examples of a maintenance targeting being completed, to increase user confidence in performing the presented maintenance targeting.

In some such embodiments, the maintenance targeting generator may access or generate a three-dimensional model of the building or a portion thereof that includes or surrounds the subject building component. For example, the maintenance targeting generator may retrieve an existing model of the building or may retrieve a two-dimensional image or plan view and extrapolate the two-dimensional image into a three-dimensional representation. Alternatively, where no model of the building is available, the maintenance targeting generator may determine whether sufficient two-dimensional source material is available (e.g., in the sample database) to approximate a three-dimensional representation of the home. For example, numerous images of a home that was previously listed on the Multiple Listing Service (MLS) may be available in the sample database or otherwise accessible, and the maintenance targeting generator may include or otherwise access image-processing and/or modelling functionality to generate a three-dimensional representation therefrom. Additionally or alternatively, the maintenance targeting generator may request or prompt the user to capture image(s) or video(s) of the space including the subject building component and may generate the three-dimensional representation using those captures. In some such embodiments, the maintenance targeting generator may generate the response including a VR representation of an avatar navigating the three-dimensional model and interacting in the space to complete the maintenance targeting.

In other embodiments, the maintenance targeting generator may generate a VR representation of the maintenance targeting using a virtual building with virtual examples of the subject building component. The maintenance targeting generator may access an existing virtual modelled space or may generate one “on the fly” (e.g., using GEN-AI functionality). In such instances, the building may not be representative of any physical building but functions as exemplary, for the purposes of providing a walkthrough of completing the maintenance target.

In some instances, the user interface may enable VR functionality. For example, the user computing device may include or be configured for communication with a VR headset (e.g., an OCULUS QUEST or GOOGLE GLASS). The VR headset may display the VR representation to the user as the user controls the avatar to navigate the virtual space. The VR representations may include first-person and/or third-person views of the avatar. The VR representations may include textual elements, audio elements, graphical elements, or other supplemental information.

In some embodiments, the maintenance targeting generator may generate a video-based representation of the maintenance targeting being performed relative to the subject building component. For example, the maintenance targeting generator may employ GEN-AI functionality to generate a life-like representation or demonstration of the maintenance targeting, in first- or third-person.

In some embodiments of the present disclosure, the maintenance targeting generator may generate and present any of the content described above as being associated with a response, but without an initiating request message or inquiry. That is, the maintenance targeting generator may proactively identify persons (e.g., active users) who may benefit from receiving information related to a subject building component, namely, a maintenance targeting.

In some instances, the maintenance targeting generator, upon identifying the maintenance targeting for the subject building component in response to an inquiry from a first user, may initiate one or more analyses of data associated with active users to determine whether the maintenance targeting may apply to their circumstances. For example, the maintenance targeting generator may parse data from one or more database (e.g., the sample database and/or the active user database) to identify users or buildings having building components the same as or similar to a subject building component identified in an inquiry and sharing at least one characteristic in common with that subject building component. The maintenance targeting generator may then “push” or otherwise proactively transmit a recommendation message (which may by functionally similar to the response messages described herein) that includes the building component and the associated maintenance targeting. In some instances, the maintenance targeting generator may only perform these proactive recommendations in response to one or more threshold criteria being satisfied, such as a particular subject building component and maintenance targeting combination being presented and/or successfully performed a threshold number of times, within a threshold geographic area or radius, within a threshold period of time, and/or any combination thereof and/or other threshold criteria.

### Incorporating Model Feedback

In some embodiments, the maintenance targeting generator (also referred to as a model feedback computing device) may seek and ingest feedback from users regarding the efficacy of presented maintenance targetings in successfully addressing a building component issue, as well as the utility or favorability of the format with which the maintenance targeting is presented. The maintenance targeting generator may then incorporate this feedback to re-train the trained machine-learning model(s) to improve the prediction capability and responsiveness of the re-trained machine-learning model(s).

More specifically, in at least some embodiments, upon presenting a maintenance targeting to a user via the user interface executed at their user computing device, the maintenance targeting generator may cause display, through the user interface, of one or more feedback prompts. The feedback prompts may encourage or request that the user provide feedback regarding whether the presented maintenance targeting was successful in addressing their inquiry. The maintenance targeting generator may also generate and cause display of feedback commands or fields that enable the user to provide the requested feedback. These feedback commands may be selectable buttons or icons (e.g., “thumbs up” or “thumbs down”; “yes” or “no”), a numerical rating option, a text-entry field, or any other suitable format enabling the user to provide the feedback. In at least some embodiments, the maintenance targeting generator may also request and enable user feedback associated with the format of the presented maintenance targeting, using any of the above-describe response options and/or any other suitable option(s). For example, the maintenance targeting generator may generate and cause display of a prompt that asks “Were the text instructions or the video options more helpful?”

The maintenance targeting generator formats any received feedback for integration back into the trained machine-learning model. For example, the maintenance targeting generator may label certain presented maintenance targetings with tags that reflect positive or negative feedback associated with efficacy and/or with maintenance targeting presentation format. The maintenance targeting generator may initiate model re-training processes that cause the trained machine-learning model to incorporate the feedback, for example, using least-cost or reward algorithms to discourage or encourage, respectively, the presentation of a same maintenance targeting under the same or similar input circumstances. The resulting (re-trained) model may therefore weigh or otherwise handle various inputs and/or discerned data relationships differently.

This “feedback loop” of model re-training, over the course of many interactions, may result in the highest-success and/or most well received maintenance targetings being presented more regularly, reducing the amount of interaction between the user computing device and the maintenance targeting generator that may be necessary for a resolution to the inquiry. In some embodiments, the maintenance targeting generator may store a set of most common maintenance targetings in a storage location for rapid retrieval without the execution of the re-trained machine-learning model. That is, under certain common circumstances, the maintenance targeting generator may parse data elements from the request message and/or inquiry, recognize the inquiry as common, and retrieve one of the most common maintenance targetings from the storage location for presentation within the user interface.

At least one technical problems addressed by this system may include: (a) inability of computing devices to identify and present users with contextually relevant maintenance or repair information related to buildings and building components; (b) inability of user interfaces to present dynamic and/or real time information to individuals about building components and interventions associated therewith using an augmented reality or virtual reality interface; (c) inability of computing devices to receive user inputs in various formats and prepare responses in various formats according to user preference and/or other criteria; and/or (d) inability of computing devices to incorporate user feedback into the generation and presentation of contextually relevant maintenance or repair information.

A technical effect of the systems and processes described herein may be achieved by performing at least one of the following: (a) ingesting sample maintenance data for a plurality of sample homes, the sample maintenance data including sample maintenance histories corresponding to each of the plurality of sample homes and sample building components thereof; (b) receiving, from a user computing device, a request message including an inquiry related to a subject building component; (c) determining a characteristic of the subject building component; (d) identifying a subject maintenance targeting based at least in part upon a subset of the sample maintenance data associated with sample building components having the same or a related characteristic; (e) processing an image or video stream captured at the user computing device, the image or video stream at least partially capturing the subject building component; and/or overlaying one or more maintenance labels onto the image or video stream in real-time in a location related to the at least partially captured subject building component, the maintenance label identifying the subject maintenance target.

A technical effect of the systems and processes described herein may additionally or alternatively be achieved by performing at least one of the following: (a) ingesting sample maintenance data for a plurality of sample homes, the sample maintenance data including sample maintenance histories corresponding to each of the plurality of sample homes and sample building components thereof; (b) training a machine-learning model using the sample maintenance data as an initial training data set; (c) receiving, from a user computing device, a request message including an inquiry related to a subject building component; (d) executing the trained machine-learning model based upon one or more data elements included in the request message to receive a model output of at least one likely maintenance targeting responsive to the inquiry; (e) presenting the at least one likely maintenance targeting; (f) receiving feedback, from the user computing device, associated with an efficacy of the at least one likely maintenance targeting; and/or (g) re-training the trained machine-learning model using the received feedback.

At least one technical effect achieved by this system may be one of: (a) computing devices technologically enabled to present a user interface that identifies and presents users with contextually relevant maintenance or repair information related to buildings and building components in response to user inquiries; (b) computing device technologically enabled to present a live or real-time, dynamically updatable overlay on image/video streams as an augmented reality display that guides users to and through maintenance and/or repair tasks; (c) computing devices technically enabled to receive user inputs, including profile entries and user inquiries, in a variety of formats (including natural language text, image, video, audio, etc.) and to generate and present responses in a parallel or different format (including text, links, video, images, AR overlays, VR representations, etc.); and/or (d) computing devices technically enables to continually improve a machine-learning model with user feedback related to the efficacy of model outputs as well as other criteria such as presentation details.

### Exemplary Computer System

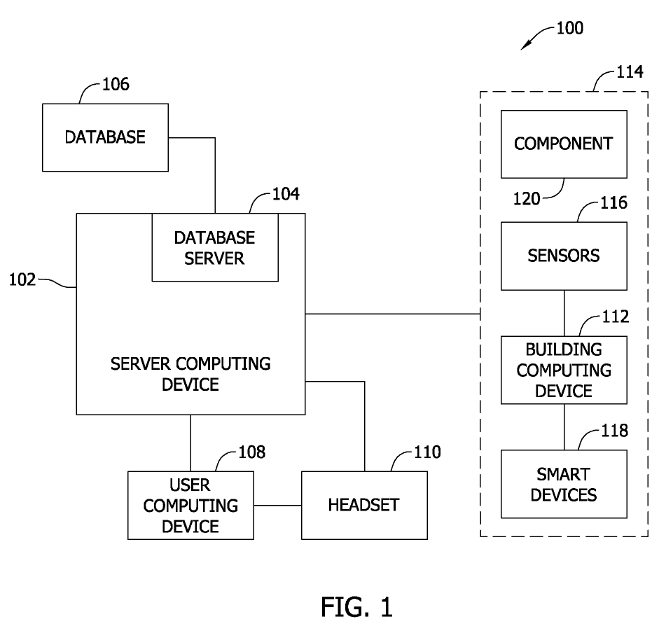

FIG. 1 depicts an exemplary computer system 100. Computer system 100 may include a maintenance targeting generator 102 including a database server 104. Computer system 100 may further include, in communication with maintenance targeting generator 102, one or more databases 106, at least one user computing device 108, and/or a headset 110. In some embodiments, user computing device 108 may be communicatively linked to headset 110.

In some embodiments, computer system 100 may further include at least one building computing device 112 disposed in and/or corresponding to a building 114 (e.g., a home), one or more sensors 116 disposed in building 114, and one or more smart devices 118 disposed in building 114. Smart devices 118 may include, for example, smart appliances, smart speakers, home monitoring devices (e.g., cameras, speakers, power monitoring devices, water or leak sensors or devices, other devices including sensors), home control devices (e.g., smart thermostats, smart light switches and/or bulbs, smart valves), or other connected devices. Building 114 further includes or is physically associated with one or more building components 120. In the exemplary embodiment, maintenance targeting generator 102 is configured to identify and/or generate at least one maintenance targeting associated with one or more building components 120 of building 114.

In the exemplary embodiment, maintenance targeting generator 102 may be configured to ingest sample maintenance data. In some instances, maintenance targeting generator 102 may include or have access to one or more databases 106 for ingesting sample maintenance data including storing the sample maintenance data. One such database 106, a sample database 106, may be built or populated by maintenance targeting generator 102 and/or by one or more other entities (e.g., users, third-party entities such as component manufacturers, insurance companies, etc.; not shown in FIG. 1). The sample maintenance data may include maintenance histories corresponding to each of a plurality of sample homes (e.g., buildings 114) and building components 120 thereof, over a historical period of time, and/or maintenance recommendations made by a manufacturer of the item or an industry organization or other organization issuing recommended maintenance plans. The maintenance histories may include building data and/or building component data (e.g., characteristics).

Data within sample database 106 may be stored and indexed by a building identifier or a building component identifier, or by any other data element. Maintenance targeting generator 106 may re-format, synthesize, or otherwise process data for storage in sample database 106. Additionally or alternatively, the maintenance target generator may access or receive building data from a third-party data store (which may be similar to database 106), such as an insurance claims history. In some instances, the sample maintenance data may also include information associated with building components that are not specific to one building 114, including data collected from internet sources or other available sources. This information may include, for example, images, text-based data (e.g., manuals or instructions), videos, and the like.

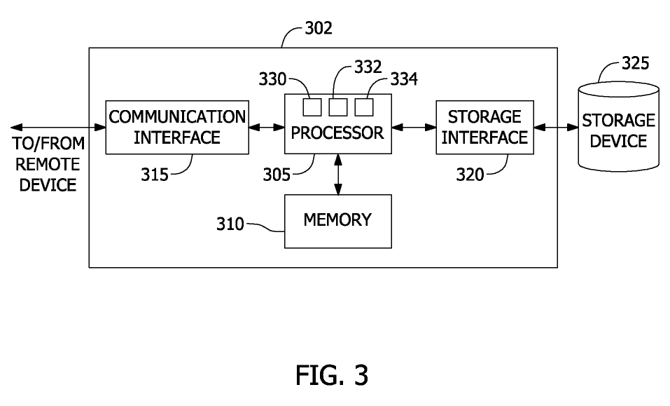

In the exemplary embodiment, maintenance targeting generator 102 may be further configured to ingest the sample maintenance data including compiling at least a subset of the sample maintenance data as an initial training data set for training one or more machine-learning models (which may be executed at an analytics module 332, shown in FIG. 3). In some instances, all available sample maintenance data may be compiled as the initial training data set. In other instances, maintenance target generator 102 may parse the sample maintenance data to include or exclude certain subset of the sample maintenance data. In some embodiments, maintenance target generator 102 may parse the sample maintenance data using one or more database queries, submitted to sample database 106, specifically constructed to exclude or include the specific desired data.

In the exemplary embodiment, the machine-learning model is trained on the initial training data set to, broadly, recognize patterns in the sample maintenance data. The trained machine-learning model is trained to receive, as input(s), data related to a subject building component 120, for example, as part of request message(s). The input data may identify a building component 120 and a related inquiry, as well as one or more characteristics of building component 120 (which may, in some instances, include a status of building component 120). Additionally or alternatively, maintenance targeting generator 102 may derive building component 120, characteristics, and/or status from other data in the request message or otherwise available. Using these data elements (or more, fewer, or alternative data elements), the trained machine-learning model is configured to output at least one potential, likely, or common (e.g., frequent) maintenance targeting associated with building component 120. As described further herein, maintenance targeting generator 102 presents (e.g., displays) at least one maintenance targeting to a requesting user (e.g., in response to an inquiry related to building component 120).

In the exemplary embodiment, maintenance targeting generator 102 is communicatively coupled to user computing device 108 via a communication network and/or interface that enables maintenance targeting generator 102 to receive data and/or messages from user computing device 108 and transmit data and/or messages to user computing device 108. For example, user computing devices may configured to execute a mobile application (“app”) that is downloaded on the user computing device 108 and enables user computing device 108 to access the functionality of maintenance targeting generator 102. Maintenance targeting generator 102 may generate data, content, and/or instructions that cause user computing device 108 to display a user interface when the app is executed on user computing device 108, the user interface enabling the transmission of data between user computing device 108 (and/or a user thereof) and maintenance targeting generator 102. The user interface may display various interactive features, including selectable options for a user of user computing device 108 to provide data inputs maintenance targeting generator 102 and/or to receive data outputs from maintenance targeting generator 102.

In the exemplary embodiment, one interactive feature of the app user interface is a selectable option to submit a request message to maintenance targeting generator 102. Maintenance targeting generator 102 may be configured to receive, from user computing device 108 (e.g., via the communicative coupling provided by the app), request messages. In some embodiments, maintenance targeting generator 102 may generate and cause display of the user interface to include a prompt for the user to submit their request message. The request message may identify building component 120 and an inquiry relating to building component 120 (e.g., a status of building component 120, a reported issue with building component 120, and/or a question about building component 120). The request message may include additional data, such as subject building component characteristics, an image or video stream or other images or videos captured by a camera and/or other sensors of user computing device 108, and/or other data relevant to providing information about subject building component 120 or associated building 114. The request message may additionally or alternatively include metadata associated with user computing device 108, such as positional data relating to a position of user computing device 108.

In the exemplary embodiment, user computing device 108 is configured to display any information, such as responses to inquiries, from maintenance targeting generator 102 within the user interface of the app. In some instances, maintenance targeting generator 102 may be configured to display information other than a response to an inquiry, such as a proactive recommendation. Maintenance targeting generator 102 may also cause display of one or more feedback prompts, screens, and/or sections of the app, enabling and encouraging user feedback related to the outputs generated and presented by maintenance targeting generator 102.

In some embodiments, maintenance targeting generator 102 may generate access to a chatbot feature, such as chatbots and/or GEN-AI (e.g., generative pre-trained transformer (GPT)-based) programs. At least some of the user interaction within the user interface of the app is facilitated by and/or conducted with the chatbot feature. Accordingly, the inquiries may be submitted in a variety of different formats interpretable by the chatbots and/or AI applications, such as natural language (e.g., text or speech), videos, images, sound recordings, and/or any other inputs that may be used. Likewise, in some instances, the chatbot and/or GEN-AI programs may be used to generate and/or display information to be included in a response to an inquiry. Accordingly, the responses may be presented in a variety of different formats, such as natural language (e.g., text or speech), links, image- or video-based (which may be retrieved or may be generated by the chatbot/GEN-AI and/or which may include VR content), real-time AR overlays, or any other outputs to be presented within the user interface, as described in greater detail herein.

In the exemplary embodiment, maintenance targeting generator 102 is configured to generate responses to received request message. As described above, such a request message may be input by a user using user computing device 108 and transmitting to maintenance targeting generator 102. In some embodiments, the maintenance targeting generator 102 may receive a request message from user computing device 108 and may parse request message to identify the inquiry, subject building component 120, and/or at least one characteristic of subject building component 120. Maintenance targeting generator 102 may parse additional data from the request message, such as included characteristics of subject building component 120, metadata associated with user computing device 108, etc. Additionally or alternatively, maintenance targeting generator 102 may be configured to process data from the request message to derive information related to subject building component 120 (e.g., using image processing, text processing, AI, and/or machine-learning techniques) to identify, for example, other building components 120 of building 114 and/or building component characteristics.

In the exemplary embodiment, maintenance targeting generator 102 may be configured to retrieve data in response to receiving the request message, for generating a response to the inquiry therein. As described herein, maintenance targeting generator 102 may be configured to execute various data processing techniques to identify at least one maintenance targeting that is related to subject building component 120 and responsive to the inquiry, based at least in part a subset of the sample maintenance data associated with sample building components having the same or a related characteristic as subject building component 120.

In the exemplary embodiment, maintenance targeting generator 102 may execute a trained machine-learning model trained on the sample maintenance data as an initial training data set. Maintenance targeting generator 102 may receive a model output of at least one potential or likely maintenance target responsive to the inquiry. The output maintenance targeting(s) represents a suggested intervention or an intervention or action most likely to address the inquiry or issue identified in the inquiry. In at least some embodiments, the trained machine-learning model may output prompts for user input to collect additional data points that may strengthen or modify the output maintenance targeting(s). Maintenance targeting generator 102, executing the trained machine-learning model, may receive the model output and, in response, generate one or more prompts that is/are presented to the user. Maintenance targeting generator 102 may process any user response and determine whether to continue presenting prompts. Maintenance targeting generator 102 may feed any user responses to the prompts back to the trained machine-learning model, which may output further prompt(s) and/or a maintenance targeting (e.g., once a sufficient confidence level or relevance level has been met).

Alternatively, maintenance targeting generator 102 may generate one or more database queries for filtering the sample maintenance data to the subset of the sample maintenance data, and query at least one database (e.g., sample database 106) using the one or more database queries to retrieve the filtered subset of the sample maintenance data for further processing. The maintenance targeting generator may the identify a maintenance targeting responsive to the inquiry based at least in part upon a subset of the sample maintenance data associated with building components having the same or a related characteristic as subject building component 120. In some embodiments, the maintenance targeting generator determines a plurality of maintenance targetings as a result of these analysis and orders potential maintenance targetings based on various factors, such as ease of performance, likelihood of success, least skill required, etc.

Based upon the maintenance targeting output from the trained machine-learning model and/or resulting from other analyses of the sample maintenance data, maintenance targeting generator 102 is configured to generate and format a response message to present the maintenance targeting(s) to the requesting user. As described herein, responses may be presented in any available format or combination thereof. In some embodiments, users may submit request messages with natural language inquiries (e.g., via text and/or voice), based upon which maintenance targeting generator 102 may generate a response (e.g., including at least one maintenance targeting) to be presented within the user interface. This response may include a description of the maintenance target, which may include instructions.

A selected format may be determined based upon a user preference or selection or input of a particular command or option (e.g., “provide text instructions,” “show me a YOUTUBE video,” “give me AR directions,” etc.). For example, maintenance targeting generator 102 may present a maintenance targeting as a text-based response based upon user selection of a text-based presentation format. Maintenance targeting generator 102 may display a maintenance targeting as an overlay over a real-time image or video stream captured at user computing device 108 (e.g., by a camera thereof) based upon user selection of an AR presentation format. Maintenance targeting generator 102 may display a maintenance targeting as a VR video based upon user selection of a VR presentation format.

In some instances, as described above, maintenance targeting generator 102 may receive the request message as an input to a chatbot displayed or active within the user interface of the app. Upon identifying a maintenance targeting for presentation, maintenance targeting generator 102 may display the chatbot including a prompt for a user of user computing device 108 to select the presentation format for the maintenance targeting generator to present the maintenance targeting.

Additionally or alternatively, such as where no preference or command is provided, maintenance targeting generator 102 may select a format based upon output from the trained machine-learning model, which may indicate the format that has received the most positive user feedback or that is most associated with a likelihood of success. Additionally or alternatively, maintenance targeting generator 102 may select a format based upon the format of the request message or inquiry that was sent by the user, or according to other criteria.

In some embodiments, the user interface may enable AR functionality. For example, user computing device 108 may include or be configured for communication with AR and/or VR headset 110. In one example, user computing device 108/headset 110 may be held or operated so that a camera of user computing device 108/headset 110 captures a live image or video stream. Maintenance targeting generator 102 may receive the live (or real-time) image or video stream, process an image or video stream captured at user computing device 108/headset 110, the image or video stream at least partially capturing subject building component 120, and generate an overlay including one or more maintenance labels representing the maintenance targeting. The overlay also includes instructions defining the location at which the maintenance labels are to be displayed, within the live image or video stream captured and displayed at user computing device 108/headset 110.

In some cases, for example, the maintenance targeting includes an intervention to be performed that is related to subject building component 120. Maintenance targeting generator 102 may generate the overlay including a graphical maintenance label conveying the intervention (e.g., arrows or directional markers, push/pull markers, icons, etc.). Maintenance targeting generator 102 may generate the overlay to additionally or alternatively include text-based maintenance labels (and/or instructions) conveying the intervention. Additionally or alternatively, the maintenance targeting is associated with a part of subject building component 120.

Maintenance targeting generator 102 may generate the overlay including a text-based maintenance label identifying the part of subject building component 120 and at least one graphical maintenance label of subject building component 120. Maintenance targeting generator 102 may further generate the overlay further including one or more other text-based maintenance labels identifying a corresponding one or more other parts of subject building component 120. The instructions control the locations of the one or more other text-based maintenance labels, such that the one or more other text-based labels do not overlap with the text-based maintenance label identifying the part of subject building component 120, when the overlay is displayed within the live image or video stream captured and displayed at user computing device 108/headset 110.

Maintenance targeting generator 102 may be configured to cause user computing device 108 to display the live image or video stream with the generated overlay, including the generated maintenance labels. The maintenance labels may be displayed as overlaid on the live image or video stream in a location related to subject building component 120 as captured in the image/video stream. For example, when viewed using user computing device 108, the overlay may be positioned within the image stream to show the maintenance labels in locations according to the generated instructions. The overlay may be continually updated based upon a position of user computing device 108, so that if user computing device 108 is moved, components of the image overlay may move within the image stream to retain their virtual position. Maintenance targeting generator 102 may additionally generate a response that causes user computing device 108 to perform different actions, such as generating audible feedback (e.g., alarms and/or audible instructions) and/or haptic feedback (e.g., vibrations), based upon a position and/or orientation and/or other data (e.g., image data) received from user computing device 108.

In another example, user computing device 108 may include or be configured for communication with AR headset 110, which may display the overlay within the user’s field of view. In either example, the display may be continually updated, so that the overlaid maintenance labels correspond to an actual location of subject building component 120 or part(s) thereof, with respect to the camera and/or headset 110.

In some embodiments, maintenance targeting generator 102 may generate one or more VR representations of subject building component 120 and the identified maintenance targeting(s). In some such embodiments, maintenance targeting generator 102 may access or generate a three-dimensional model of building 114 or a portion thereof that includes or surrounds subject building component 120. For example, maintenance targeting generator 102 may retrieve an existing model of building 114 or may retrieve a two-dimensional image or plan view and extrapolate the two-dimensional image into a three-dimensional representation. Alternatively, where no model of the building is available, maintenance targeting generator 102 may determine whether sufficient two-dimensional source material is available (e.g., in sample database 106) to approximate a three-dimensional representation of building 114 to apply image-processing and/or modelling functionality to generate a three-dimensional representation therefrom. Additionally or alternatively, maintenance targeting generator 102 may request or prompt the user to capture image(s) or video(s) of the space including subject building component 120 and may generate the three-dimensional representation using those captures.

In some such embodiments, maintenance targeting generator 102 may generate the response including a VR representation of an avatar navigating the three-dimensional model and interacting in the space to complete the maintenance targeting. In other embodiments, maintenance targeting generator 102 may generate a VR representation of the maintenance targeting using a virtual building with virtual examples of subject building component 120. Maintenance targeting generator 102 may access an existing virtual modelled space or may generate one “on the fly” (e.g., using GEN-AI functionality). In some instances, the user interface may enable VR functionality. For example, user computing device 108 may include or be configured for communication with VR headset 110, which may display the VR representation to the user as the user controls the avatar to navigate the virtual space.

In some embodiments, maintenance targeting generator 102 may generate a video-based representation of the maintenance targeting being performed relative to subject building component 120. For example, maintenance targeting generator 102 may employ GEN-AI functionality to generate a life-like representation or demonstration of the maintenance targeting, in first- or third-person.

In some embodiments of the present disclosure, maintenance targeting generator 102 may generate and present any of the content described above as being associated with a response, but without an initiating request message or inquiry. That is, maintenance targeting generator 102 may proactively identify persons (e.g., active users) who may benefit from receiving information related to subject building component 120, namely, a maintenance targeting. In some instances, maintenance targeting generator 102, upon identifying the maintenance targeting for subject building component 120 in response to an inquiry from a first user, may initiate one or more analyses of data associated with active users to determine whether the maintenance targeting may apply to their circumstances. Maintenance targeting generator 102 may then “push” or otherwise proactively transmit a recommendation message (which may by functionally similar to the response messages described herein) that identifies the building component and includes the associated maintenance targeting.

In some embodiments, maintenance targeting generator 102 (also referred to as a model feedback computing device 102) may seek and ingest feedback from users regarding the efficacy of presented maintenance targetings in successfully addressing a building component issue, as well as the utility or favorability of the format with which the maintenance targeting is presented. Maintenance targeting generator 102 may then incorporate this feedback to re-train the trained machine-learning model(s) to improve the prediction capability and responsiveness of the re-trained machine-learning model(s).

In at least some embodiments, upon presenting a maintenance targeting to a user via the user interface executed at their user computing device, maintenance targeting generator 102 may cause display, through the user interface, of one or more feedback prompts, encouraging or requesting that the user provide feedback regarding whether the presented maintenance targeting was successful in addressing their inquiry. In at least some embodiments, maintenance targeting generator 102 may also request and enable user feedback associated with the format of the presented maintenance targeting.

Maintenance targeting generator 102 formats any received feedback for integration back into the trained machine-learning model. For example, maintenance targeting generator 102 may label certain presented maintenance targetings with tags that reflect positive or negative feedback associated with efficacy and/or with maintenance targeting presentation format. Maintenance targeting generator 102 may initiate model re-training processes that cause the trained machine-learning model to incorporate the feedback, for example, using least-cost or reward algorithms to discourage or encourage, respectively, the presentation of a same maintenance targeting under the same or similar input circumstances. The resulting (re-trained) model may therefore weigh or otherwise handle various inputs and/or discerned data relationships differently.

In some embodiments, maintenance targeting generator 102 may store a set of most common maintenance targetings in a storage location for rapid retrieval without the execution of the re-trained machine-learning model. That is, under certain common circumstances, maintenance targeting generator 102 may parse data elements from the request message and/or inquiry, recognize the inquiry as common, and retrieve one of the most common maintenance targetings from the storage location for presentation within the user interface.

### Exemplary Client Computing Device

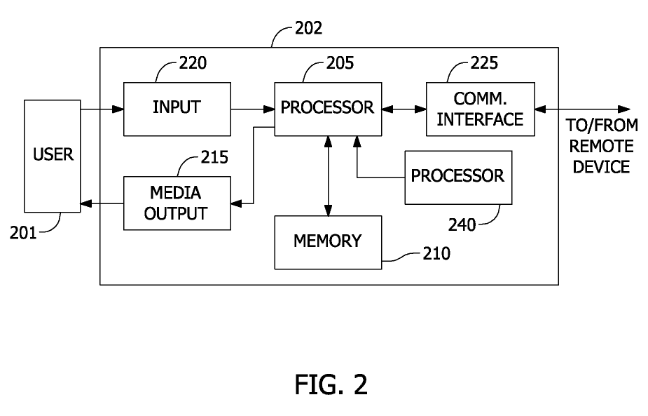

FIG. 2 depicts an exemplary client computing device 202. Client computing device 202 may be, for example, at least one of user computing device, headset 110, building computing device 112, and/or smart devices 118 (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In certain exemplary embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as maintenance target generator 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

In some embodiments, client computing device 202 may also include sensors 240. Sensors 240 may include, for example, accelerometers, a global positioning system (GPS), gyroscopes, water sensors, smoke or fire sensors, electrical sensors, temperature sensors, pressure sensors, humidity sensors, and/or other types of sensors. Sensors 240 may be used to collect sensor data, which may be transmitted by client computing device 202 to a remote device such as maintenance target generator 102.

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from maintenance target generator 102 (shown in FIG. 1). For example, as described with respect to FIG. 1, a mobile app may provide a user interface that enables a user to, for example, search for information and submit inquiries, view images and instructions, view AR and/or VR interfaces, and/or otherwise access information that may be presented by maintenance target generator 102.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary Server System

FIG. 3 depicts an exemplary server system 302 that may be used with computer system 100 illustrated in FIG. 1. Server system 302 may be, for example, maintenance target generator 102 (shown in FIG. 1).

In exemplary embodiments, server system 302 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 302, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 302 is capable of communicating with user computing device 108, headset 110, and/or building computing device 112 (all shown in FIG. 1), or another server system 302. For example, communication interface 315 may receive requests from user computing device 108, headset 110, and/or building computing device 112 via the Internet.

Processor 305 may also be operatively coupled to a storage device 325, such as database 106 (shown in FIG. 1). Storage device 325 may be any computer-operated hardware suitable for storing and/or retrieving data. In some embodiments, storage device 325 may be integrated in server system 302. For example, server system 302 may include one or more hard disk drives as storage device 325.

In other embodiments, storage device 325 may be external to server system 302 and may be accessed by a plurality of server systems 302. For example, storage device 325 may include multiple storage units such as hard disks or solid-state disks in a redundant array of inexpensive disks (RAID) configuration. Storage device 325 may include a storage area network (SAN) and/or a network attached storage (NAS) system.

In some embodiments, processor 305 may be operatively coupled to storage device 325 via a storage interface 320. Storage interface 320 may be any component capable of providing processor 305 with access to storage device 325. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 325.

In exemplary embodiments, processor 305 may include and/or be communicatively coupled to one or more modules for implementing the systems and methods described herein. In some embodiments, processor 305 may include one or more of a communication module 330, an analytics module 332, and/or a graphics module 334.

In some embodiments, communications module 330 may be configured to orchestrate transmitting data to and receiving data from external devices such as, for example, user computing device 108, headset 110, and/or building computing device 112. In some embodiments, analytics module 332 may be configured to make determinations based upon input data (e.g., sample maintenance data, subject building component data, etc.), for example, by performing lookups and/or queries within databases (e.g.¸ database 106), transmitting queries to one or more other data sources (not shown), executing OCR and/or other algorithms, and/or by executing chatbots, AI and/or machine learning techniques as described above. In some embodiments, graphics module 334 may be configured to generate graphical interfaces for display at, for example, user computing device 108 and/or headset 110.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

### Exemplary User Interface

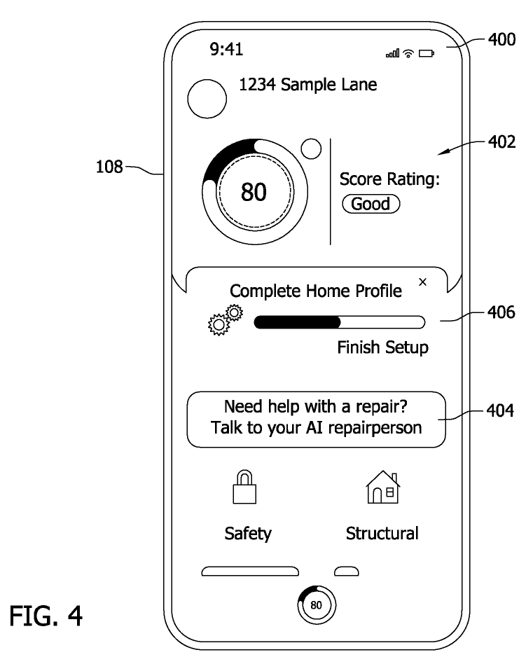

FIG. 4 depicts an exemplary user interface 400 that may be generated by, for example, computing device 102 and displayed by, for example, user computing device 108 (both shown in FIG. 1). In some embodiments, user interface 400 may be a “home screen” or other landing page that a user is presented with by default when executing the mobile app on user computing device 108. User interface 400 may display details 402 related to a building owned by or otherwise associated with the user, such as an address, building value, building data, user or building profile information, etc.

In the exemplary embodiment, user interface 400 further includes a selectable option 404 to initiate a request message. In some embodiments, selection of option 404 activates or navigates the user interface to a chatbot or other AI/GEN-AI messaging functionality as described elsewhere herein. In this illustration, option 404 indicates the function thereof with a text-based caption “Need help with a repair? Talk to your AI repairperson”. In other instances, the caption may include any other text and/or graphical indicator(s) to indicate to the user that selection of option 404 enables them to prepare request messages, such as to ask questions and get consultation from AI on issues they are having on their property (e.g., their home).

As described herein, the user may interact with the chatbot using natural language inputs and receive natural language outputs therefrom, mimicking (to some extent) a conversation with a human. In some instances, the user may submit inquiries via the chatbot interface using statements about the subject building component and a question that contextualizes the inquiry. For example, but without limitation, a user may submit their inquiry as a natural language text input: “Water is dripping from my showerhead. What should I do?” or “My garage door sometimes reopens when I try to close it. What’s going on?” or “There’s a leak under my sink. How can I fix this?” The maintenance targeting generator receives the inquiry within a request message that may include other data, such as images captured by the user computing device in conjunction with the inquiry, building profile data previously submitted by the user, metadata from the user computing device, etc.

In some embodiments, the chatbot may respond (e.g., using AI or GEN-AI functionality provided by computing device 102) with additional questions to retrieve more information from the user that will further contextualize the inquiry and improve the likelihood that the presented response includes a maintenance targeting that addresses the inquiry. In some embodiments, the chatbot may present certain maintenance targetings without accessing the modelling/data processing features of computing device 102, as described above, such as simple maintenance targetings responsive to a set of most common inquiries.

In the illustrated embodiment, user interface 400 also includes a selectable option 406 to modify their “home profile,” or the profile of the building associated with the user. Selection of option 406 may navigate the user interface to a data entry page, in which the user may input building data, building components, characteristics of building components, etc. The user may input data using text, natural-language entries, images, videos, links to external websites (e.g., an MLS listing), etc.

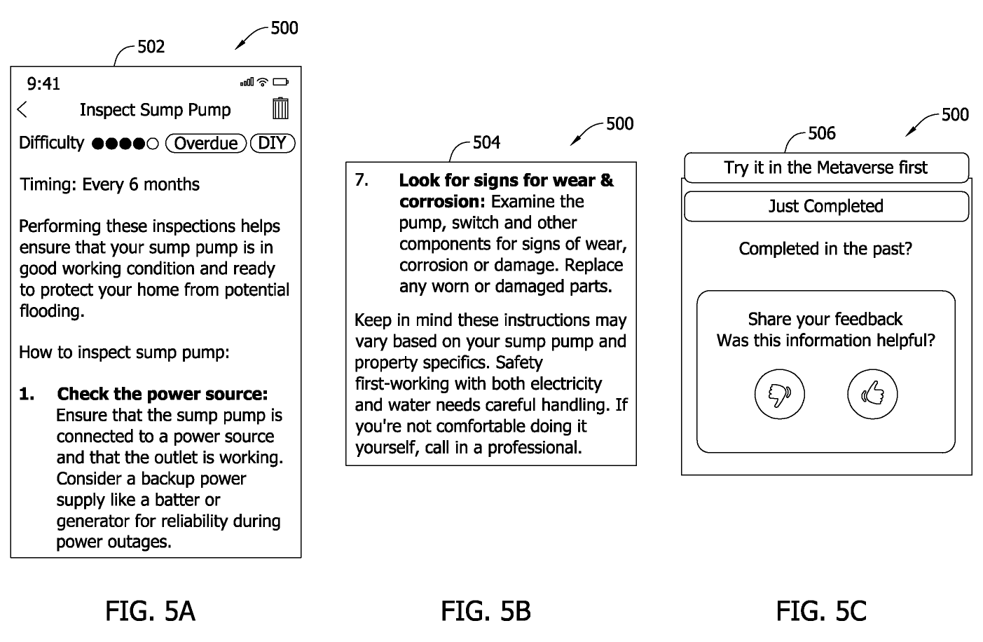

FIGS. 5A-5C depict a sequence of screens 502, 504, 506 of an exemplary user interface 500 that may be generated by, for example, computing device 102, and displayed by, for example, user computing device 108. In some instances, screen 504 is made available by scrolling or panning from screen 502, and screen 506 is made available by scrolling or panning from screen 504. In other instances, screens 502, 504, 506 may be available on different pages.

User interface 500 may represent the presentation of a maintenance targeting as a text-based response to a user inquiry, in this example related to a sump pump not operating properly. As shown in screen 502, the maintenance targeting includes a title 510, as well as descriptive data 512 such as a difficulty level and, in this example, a recommended periodicity. The maintenance targeting continues, from step 1 (shown in screen 502) to step 7 (shown in screen 504) to guide the user through the inspection of the sump pump using the text-based instructions.

When the user reaches the end of the maintenance targeting, in the exemplary embodiment, the user is presented with various selectable options (shown in screen 506). A completion option 514, when selected, indicates that the user has completed the maintenance targeting. In some instances, selection of option 514 implies successful completion, such as where an alternative option (not shown) may be available, which the user may select to indicate the maintenance targeting was not completed. Additionally or alternatively, the success of the maintenance targeting is inferred based upon the user’s feedback provided using the feedback options 516. For instance, positive feedback (e.g., the “thumbs up”, or a check mark or plus sign) may indicate the maintenance targeting was successfully completed, whereas negative feedback (e.g., the “thumbs down”, or an “X” or minus sign) may indicate the maintenance targeting was not successfully completed. Still further, additional options or feedback controls may be provided that enable more granular reactions from the user. For example, a user may successfully complete the maintenance targeting but the maintenance targeting may not solve the problem; it would be useful, in such circumstances, to provide selectable options that enable the user to provide specific and detailed reactions.

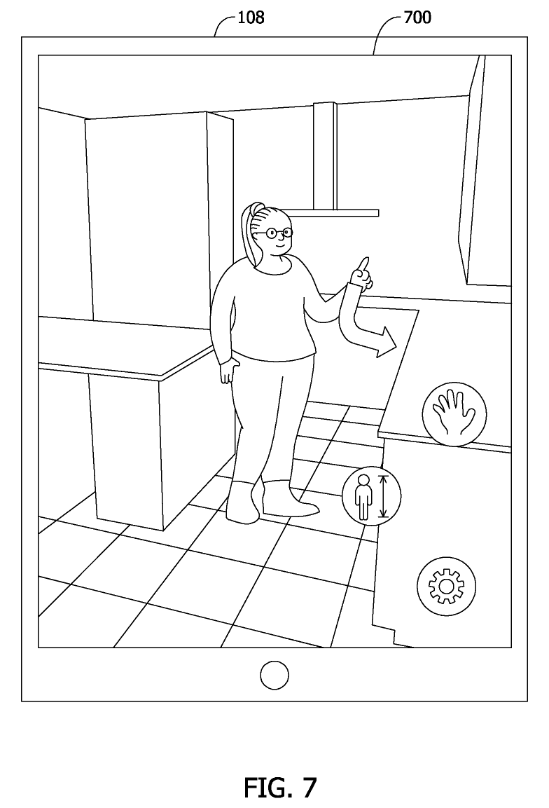

In addition, the user is presented with a selectable option 520 to be presented with the maintenance targeting in an alternative or additional format, in this instance, in a VR representation “in the METAVERSE”. Upon selection of option 520, computing device 102 may generate and/or cause display of a generated VR representation that displays a model of the user’s home (or an example home) and a first-person or third-person view of an avatar (which may appear as or represent the user) performing the actions of the maintenance targeting, as shown in FIGS. 7 and 14-16, for example. Upon completion of the VR representation, in some embodiments, the user may select still further display formats, such as an AR overlay display format that provides an overlaid walkthrough of the maintenance targeting over a live image or video stream captured by user computing device 108.

### Exemplary Augmented Reality Interfaces

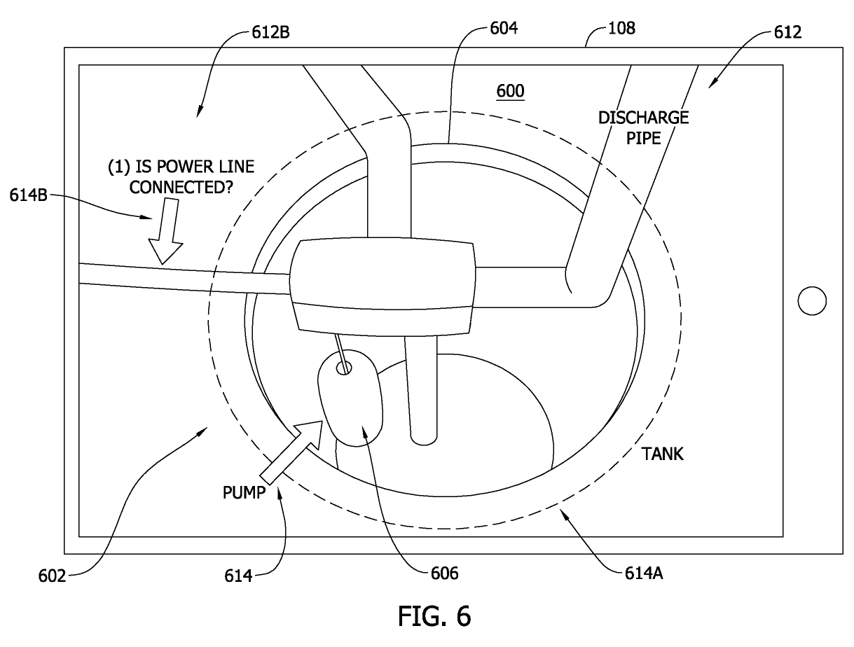

FIG. 6 depicts an exemplary AR interface 600. AR interface 600 may be generated by, for example, computing device 102 and displayed by, for example, user computing device 108 and/or an AR or VR headset (e.g., headset 110; all shown in FIG. 1). For the purposes of illustration, AR interface 600 may represent an AR representation of the maintenance targeting discussed with respect to FIGS. 5A-5C (i.e., the inspection of a sump pump).

The user may access a mobile app using user computing device 108 and/or headset 110. The user may then input an inquiry related to operation of sump pumps. The inquiry may include, for example, search terms (“sump pump basement”), natural language text and/or speech (“There is water around my sump pump. What can I do to fix it?”), selection from a menu of options, or other inputs that convey that the user wishes to review and/or perform one or more remedial actions related to operation of the sump pump. For instance, in some embodiments, the user may access the mobile app and initiate capturing real-time image or video data of the sump pump using, for example, a camera of user computing device 108 and/or headset 110, and the system (e.g., computing device 102) may use various image processing functionality to identify that there is a building component within the real-time image/video stream, and, in some further instances, that the building component is a sump pump. The system (e.g., computing device 102) may process a user inquiry (which may include the above-described real-time image/video stream) and generate AR interface 600 in response thereto.

The generated AR interface 600 may be displayed by user computing device 108 and/or headset 110 via the mobile app. AR interface 600 may include a background, which may include photographic imagery captured by, for example, a camera of user computing device 108 and/or headset 110. This photographic imagery may be continually updated in real time (e.g., by periodically or continuously capturing new images with the camera) so that AR interface 600 represents a present view of or within, for example, building 114, and/or of the subject building component 120, namely, the sump pump. Alternatively, the background may be virtual representation of building 114 and/or building component 120, rather than a live image/video.

In this example case, the background may include (e.g., depict live images/video of) a subject building component including a sump pump assembly 602, which generally shows the parts of sump pump assembly 602 that are above grade as well as the pump tank 604 and sump pump 606 in pump tank 604.

Additionally, AR interface 600 includes an overlay 610 generated by computing device 102 in response to the inquiry. In this example, overlay 610 includes a plurality of maintenance labels, including text-based labels 612 and graphical labels 614. Overlay 610 also includes instructions defining the relative location of labels 612, 614 relative to the background (i.e., the live, real-time image or video stream). For instance, a graphical label 614A associated with pump tank 604 is displayed or overlaid in in a location related to pump tank 604 (e.g., surround pump tank 604). As another example, a text-based label 612B and a graphical label 614B are displayed in a location relative to an electrical box 608 of sump pump assembly 602. Text-based label 612B also references the step of maintenance targeting that label 612B is associated with, along with a prompt to action. Graphical label 614B visually relates text-based label 612B with the part of sump pump assembly 602 to which it applies.

In some embodiments, the locations of labels 612, 614 are further defined relative to one another. For example, text-based labels 612 may be controlled to not overlap one another to ensure readability of overlay 610. Certain labels 612, 614 may be controlled to not overlap the building component or part(s) thereof, where such overlap may detract from the utility of overlay 610.

The locations of overlay 610 may be continually refreshed (e.g., a location and/or angle of the camera changes with respect to the location of sump pump assembly 602) so that the locations of overlay 610 remain corresponding to the actual locations of the applicable elements of sump pump assembly 602.

While FIG. 6 illustrates an example in which a user is instructed to inspect a sump pump assembly, similar interfaces may be generated to provide instruction relating to other issues and/or maintenance or household tasks, which may include generated overlays similar to overlay 610.

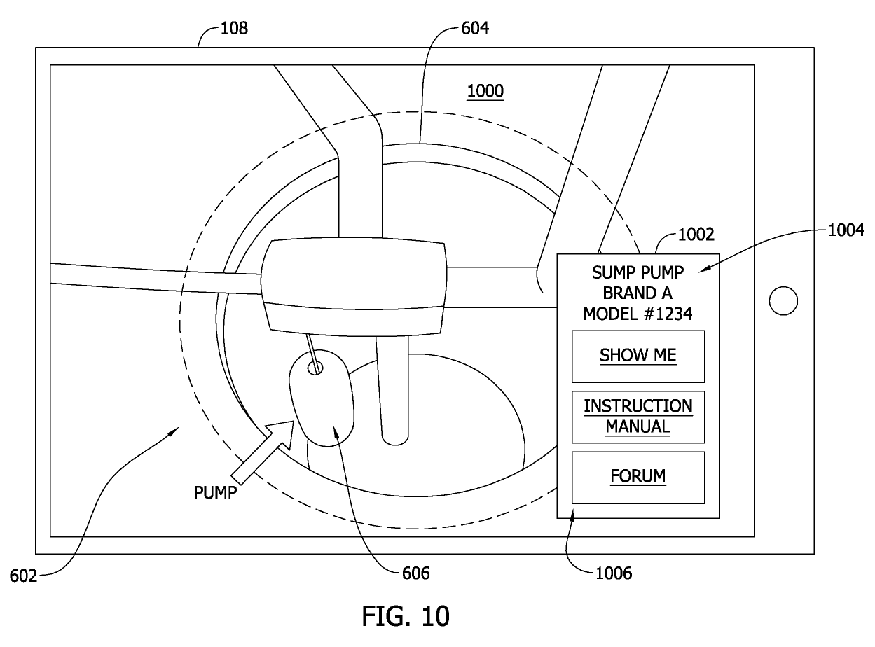

With reference now to FIG. 10, another exemplary AR interface 1000 is depicted. AR interface 1000 may be similar to AR interface 600, in that AR interface 1000 may be generated by, for example, computing device 102 and displayed by, for example, user computing device 108 and/or an AR or VR headset (e.g., headset 110; all shown in FIG. 1). For the purposes of illustration, AR interface 1000 may represent an alternative to AR interface 600 or a complementary AR interface, such as an AR interface that is generated and/or displayed before or after AR interface 600. Therefore, in this example, AR interface 1000 also represents an AR representation of the maintenance targeting discussed with respect to FIGS. 5A-5C and 6 (i.e., the inspection of a sump pump).

The user may access a mobile app using user computing device 108 and/or headset 110. The user may then input an inquiry related to operation of sump pumps. The inquiry may include, for example, search terms (“sump pump basement”), natural language text and/or speech (“There is water around my sump pump. What can I do to fix it?”), selection from a menu of options, or other inputs that convey that the user wishes to review and/or perform one or more remedial actions related to operation of the sump pump. For instance, in some embodiments, the user may access the mobile app and initiate capturing real-time image or video data of the sump pump using, for example, a camera of user computing device 108 and/or headset 110, and the system (e.g., computing device 102) may use various image processing functionality to identify that there is a building component within the real-time image/video stream, and, in some further instances, that the building component is a sump pump. The system (e.g., computing device 102) may process a user inquiry (which may include the above-described real-time image/video stream) and generate AR interface 1000 in response thereto.

The generated AR interface 1000 may be displayed by user computing device 108 and/or headset 110 via the mobile app. AR interface 1000 may include a background, which may include photographic imagery captured by, for example, the camera of user computing device 108 and/or headset 110. This photographic imagery may be continually updated in real time (e.g., by periodically or continuously capturing new images/video with the camera) so that AR interface 1000 represents a present view of or within, for example, building 114, and/or of the subject building component 120, namely, the sump pump. Alternatively, the background may be virtual representation of building 114 and/or building component 120, rather than a live image/video.

In this example case, the background may include (e.g., depict live images of) a subject building component including sump pump assembly 602, pump tank 604, and sump pump 606 in pump tank 604.

In the exemplary embodiment, as described above, computing device 102 may be configured to identify a building component depicted in a real-time image/video stream, and/or in one or more images or videos that may have been previously captured and provided to computing device 102 as part of the inquiry. In this example case, computing device 102 may identify the depicted building component as sump pump assembly 602 and/or sump pump 606 (e.g., using image/video processing functionality, which may include artificial intelligence (AI) and/or machine learning (ML) techniques). Moreover, computing device 102 may further identify one or more characteristics of the building component (e.g., using image/video processing functionality, which may include artificial intelligence (AI) and/or machine learning (ML) techniques). In the example case, computing device 102 may be configured to identify a brand, model, year, etc. of sump pump 606. In so doing, computing device 102 may tailor responses to the inquiry to that specific sump pump 606 brand/model/year.

In some embodiments, computing device 102 may use the identified building characteristics to query one or more databases (e.g., sample database 106, shown in FIG. 1) for resources related to the subject building component (e.g., “sump pumps” in general) and/or one more identified building characteristics (e.g., the brand of sump pump 606, the model of sump pump 606, etc.). The resources may include, for example, user manuals, troubleshooting guides, installation guides, and the like. Additionally or alternatively, computing device 102 queries one or more dynamic data sources other than a database of computer system 100, such as various Internet sources.

In the illustrated embodiment, AR interface 1000 includes an overlay 1002 generated by computing device 102 (e.g., in response to the inquiry). In this example, overlay 1002 includes various details or data elements 1004 that computing device 102 has identified (and/or that have been provided to computing device 102 as part of the inquiry), including the subject building component (“SUMP PUMP”), a brand (“BRAND A”), and a model number (“MODEL #1234”) thereof.

In addition, computing device 102 may provide to the user of computing device 108 various selectable options 1006 from which the user may select, depending on their preferences. In this particular illustrated, the options 1006 include a “SHOW ME” option, an “INSTRUCTION MANUAL” option, and a “FORUM” option. Upon selection of the “SHOW ME” option, computing device 102 may update AR interface 1000 with one or more instructional overlays, including text, graphics, etc., to walk the user through diagnostic or repair procedure(s) related to sump pump 606. These instructional overlays may include customized content that is dynamically generated specific to the inquiry and/or depicted scene. For example, as described herein, computing device 102 may implement one or more AI techniques to generate instructional content for display to the user on AR interface 1000.

Upon selection of the “INSTRUCTION MANUAL” option, computing device 102 may update a display of user computing device 108 to display static content from an instruction manual related to the subject building component. The instruction manual may be displayed on a separate screen, temporarily overriding the AR functionality while the user reviews the content of the manual. Alternatively, computing device 102 may dynamically “cut” sections of the instruction manual for display as a separate overlay on AR interface 1000, such that the user may read relevant content form the manual without leaving the AR interface.

Upon selection of the “FORUM” option, computing device 102 may update a display of user computing device 108 to display online (Internet) content from a forum or other user-driven source, that is related to building component, brand, and/or model thereof. For example, computing device 102 may query a particular web domain (e.g., REDDIT) with the brand and model number to determine that user-driven content related to sump pump 606 exists on that domain, and may generate the “FORUM” option such that, upon selection thereof, the user is navigated to a webpage including that user-driven content. In some embodiments, where no such content is identified and/or available, computing device 102 may not generate and/or display the “FORUM” option.

In the example embodiment, overlay 1002 may also include instructions defining the relative location thereof relative to the background (i.e., the live, real-time image or video stream). For instance, the instructions may control the location of overlay 1002 such that overlay 1002 does not restrict the real-time display of the subject building component (e.g., sump pump 606). As such, in some embodiments, the location of overlay 1002 may be continually refreshed as a location and/or angle of the camera changes with respect to the location of sump pump assembly 602. In some embodiments, AR interface 1000 may include more AR overlays, similar to those described above with respect to FIG. 6, such as text-based maintenance labels and/or graphical maintenance labels.

While FIG. 10 illustrates an example in which a user is instructed to inspect a sump pump assembly, similar interfaces may be generated to provide instruction relating to other issues and/or maintenance or household tasks, which may include generated overlays similar to overlay 1002.

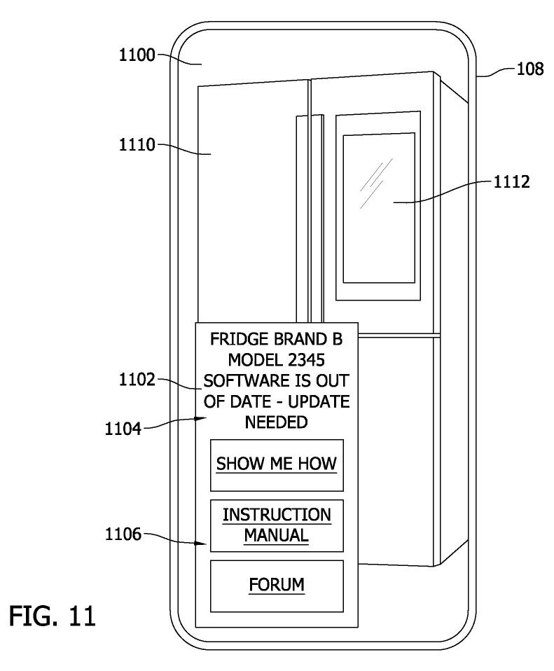

For example, FIG. 11 depicts another exemplary AR interface 1100 demonstrating a software update task. AR interface 1100 may be similar to AR interface 600 and/or AR interface 1000, in that AR interface 1200 may be generated by, for example, computing device 102 and displayed by, for example, user computing device 108 and/or an AR or VR headset (e.g., headset 110; all shown in FIG. 1). In this example, AR interface 1100 represents an AR representation of a maintenance targeting including a software update.

The user may access a mobile app using user computing device 108 and/or headset 110. The user may then input an inquiry related to operation of a smart appliance, such as a smart refrigerator. The inquiry may include, for example, search terms (“smart fridge glitch”), natural language text and/or speech (“My refrigerator isn’t showing the right temperature. What can I do?”), selection from a menu of options, or other inputs that convey that the user wishes to review and/or perform one or more remedial actions related to operation of the smart refrigerator. For instance, in some embodiments, the user may access the mobile app and initiate capturing real-time image or video data of the smart refrigerator using, for example, a camera of user computing device 108 and/or headset 110, and the system (e.g., computing device 102) may use various image processing functionality to identify that there is a building component within the real-time image/video stream, and, in some further instances, that the building component is a smart appliance. The system (e.g., computing device 102) may process a user inquiry (which may include the above-described real-time image/video stream) and generate AR interface 1100 in response thereto.

The generated AR interface 1100 may be displayed by user computing device 108 and/or headset 110 via the mobile app. AR interface 1100 may include a background, which may include photographic imagery captured by, for example, the camera of user computing device 108 and/or headset 110. This photographic imagery may be continually updated in real time (e.g., by periodically or continuously capturing new images/video with the camera) so that AR interface 1100 represents a present view of or within, for example, building 114, and/or of the subject building component 120, namely, a smart refrigerator 1110. Alternatively, the background may be virtual representation of building 114 and/or building component 120, rather than a live image/video.

In the exemplary embodiment, as described above, computing device 102 may be configured to identify a building component depicted in a real-time image/video stream, and/or in one or more images or videos that may have been previously captured and provided to computing device 102 as part of the inquiry. In this example case, computing device 102 may identify the depicted building component as smart refrigerator 1110 (e.g., using image/video processing functionality, which may include artificial intelligence (AI) and/or machine learning (ML) techniques). Moreover, computing device 102 may further identify one or more characteristics of the building component (e.g., using image/video processing functionality, which may include artificial intelligence (AI) and/or machine learning (ML) techniques). In the example case, computing device 102 may be configured to identify a brand, model, year, etc. of smart refrigerator 1110. Moreover, in at least some embodiments, computing device 102 may identify, based upon details within the inquiry, an image depicted on an interactive screen 1112, or other inputs/determinations, a software version being run by smart refrigerator 1110. In so doing, computing device 102 may tailor responses to the inquiry to that specific smart refrigerator brand/model/year as well as software version.

In some embodiments, computing device 102 may use the identified building characteristics to query one or more databases (e.g., sample database 106, shown in FIG. 1) for resources related to the subject building component (e.g., “refrigerators” or “smart refrigerators” in general) and/or one more identified building characteristics (e.g., the brand of smart refrigerator 1110, etc.). The resources may include, for example, user manuals, troubleshooting guides, installation guides, and the like. Additionally or alternatively, computing device 102 queries one or more dynamic data sources other than a database of computer system 100, such as various Internet sources.

In the illustrated embodiment, AR interface 1100 includes an overlay 1102 generated by computing device 102 (e.g., in response to the inquiry). In this example, overlay 1102 includes various details or data elements 1104 that computing device 102 has identified (and/or that have been provided to computing device 102 as part of the inquiry), including the subject building component (“FRIDGE”), a brand (“BRAND B”), and a model number (“MODEL #2345”) thereof. Overlay 1102 may further include an identification of one potential maintenance targeting to attempt – in this instance, “SOFTWARE IS OUT OF DATE – UPDATE NEEDED.”

In addition, computing device 102 may provide to the user of computing device 108 various selectable options 1106 from which the user may select, depending on their preferences. In this particular illustrated, the options 1106 include a “SHOW ME” option, an “INSTRUCTION MANUAL” option, and a “FORUM” option. Upon selection of the “SHOW ME” option, computing device 102 may update AR interface 1100 with one or more instructional overlays, including text, graphics, etc., to walk the user through a software update procedure. These instructional overlays may include customized content that is dynamically generated specific to the inquiry and/or depicted scene. For example, as described herein, computing device 102 may implement one or more AI techniques to generate instructional content for display to the user on AR interface 1100, such as sample screen captures of various steps the user may encounter.

Upon selection of the “INSTRUCTION MANUAL” option, computing device 102 may update a display of user computing device 108 to display static content from an instruction manual related to the subject building component, such as text-based (and/or pictorial) instructions. The instruction manual may be displayed on a separate screen, temporarily overriding the AR functionality while the user reviews the content of the manual. Alternatively, computing device 102 may dynamically “cut” sections of the instruction manual for display as a separate overlay on AR interface 1100, such that the user may read relevant content form the manual without leaving the AR interface.

Upon selection of the “FORUM” option, computing device 102 may update a display of user computing device 108 to display online (Internet) content from a forum or other user-driven source, that is related to building component, brand, and/or model thereof. For example, computing device 102 may query a particular web domain (e.g., REDDIT) with the brand and model number to determine that user-driven content related to sump pump 606 exists on that domain, and may generate the “FORUM” option such that, upon selection thereof, the user is navigated to a webpage including that user-driven content. In some embodiments, where no such content is identified and/or available, computing device 102 may not generate and/or display the “FORUM” option.

In the example embodiment, overlay 1102 may also include instructions defining the relative location thereof relative to the background (i.e., the live, real-time image or video stream). For instance, the instructions may control the location of overlay 1102 such that overlay 1002 does not restrict the real-time display of the subject building component (e.g., the screen 1112 of smart refrigerator 1110). As such, in some embodiments, the location of overlay 1102 may be continually refreshed as a location and/or angle of the camera changes with respect to the location of smart refrigerator 1110. In some embodiments, AR interface 1000 may include more AR overlays, similar to those described above with respect to FIG. 6, such as text-based maintenance labels and/or graphical maintenance labels.

While FIG. 11 illustrates an example in which a user is instructed to update smart appliance software, similar interfaces may be generated to provide instruction relating to other issues and/or maintenance or household tasks, which may include generated overlays similar to overlay 1102.

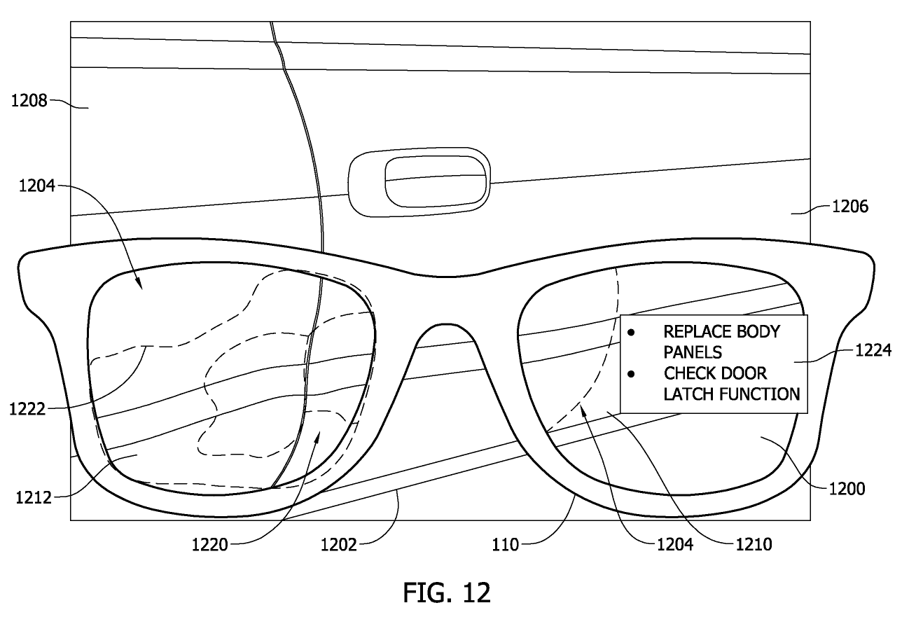

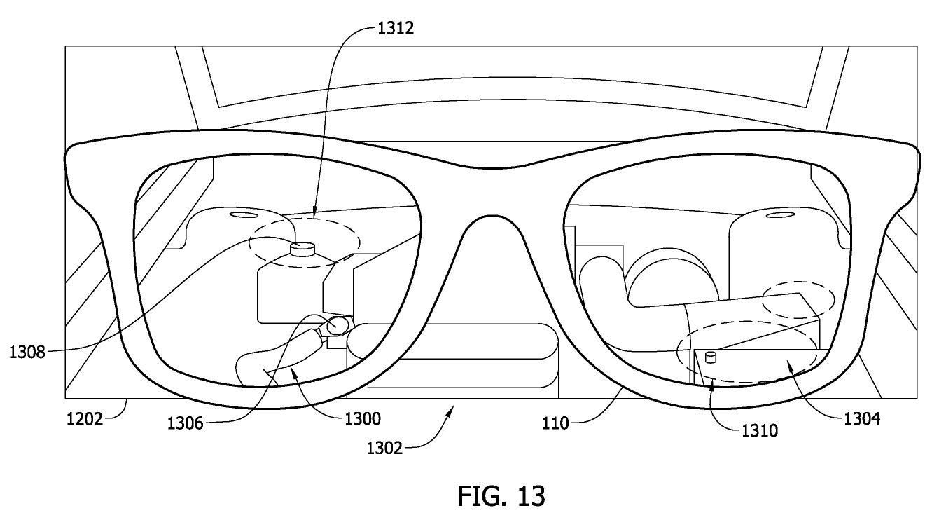

For example, FIGS. 12 and 13 depict exemplary AR interfaces 1200, 1300, respectively, that relate to maintenance and/or repair of vehicles. In such embodiments, the functionality of system 100 may be applied to assist persons in vehicle repair or maintenance, including for the purposes of training or teaching newer employees.

Specifically, in FIG. 12, the depicted AR interface 1200 may be similar to AR interface 600 and/or AR interface 1000, in that AR interface 1200 may be generated by, for example, computing device 102 and displayed by, for example, an AR/VR headset 110 and/or a user computing device 108. In this example, AR interface 1200 may be an AR representation of a maintenance targeting related to vehicles, such as the detection or identification and/or repair of vehicle body damage.

The user may access a mobile app using headset 110 and/or user computing device 108. The user may then input an inquiry related to maintenance or repair of vehicles. The inquiry may include, for example, search terms (“door dent panel”), natural language text and/or speech (“This vehicle has a passenger side dent. What parts to I need?”), selection from a menu of options, or other inputs that convey that the user wishes to review and/or perform one or more remedial actions related to repair of a vehicle. For instance, in some embodiments, the user may access the mobile app and initiate capturing real-time image or video data of the vehicle using, for example, a camera of headset 110, and the system (e.g., computing device 102) may use various image processing functionality to identify that there is a subject component (e.g., a “subject vehicle component,” in the context of the present example) within the real-time image/video stream, and, in some further instances, that the subject component is one or more parts of a vehicle (e.g., a front door, a rear door, one or more body panels, etc.). The system (e.g., computing device 102) may process a user inquiry (which may include the above-described real-time image/video stream) and generate AR interface 1200 in response thereto.

The generated AR interface 1200 may be displayed by headset 110 and/or user computing device 108. AR interface 1200 may include a background, which may include photographic imagery captured by, for example, the camera of headset 110 and/or user computing device 108. This photographic imagery may be continually updated in real time (e.g., by periodically or continuously capturing new images/video with the camera) so that AR interface 1200 represents a present view of or within, for example, a vehicle 1202, and/or of a subject vehicle component 1204, which may include, in this example, one or more vehicle doors and/or side body panels. Alternatively, the background may be a virtual representation of vehicle 1202 and/or vehicle component 1204, rather than a live image/video.

In the exemplary embodiment, as described above, computing device 102 may be configured to identify a subject component (e.g., a subject vehicle component) depicted in a real-time image/video stream, and/or in one or more images or videos that may have been previously captured and provided to computing device 102 as part of the inquiry. In this example case, computing device 102 may identify the depicted vehicle component 1204 as a front passenger door 1206, a rear passenger door 1208, a first body panel 1210, and a second body panel 1212 (e.g., using image/video processing functionality, which may include artificial intelligence (AI) and/or machine learning (ML) techniques).

Moreover, computing device 102 may further identify one or more characteristics of the vehicle component (e.g., using image/video processing functionality, which may include artificial intelligence (AI) and/or machine learning (ML) techniques). In the example case, computing device 102 may be configured to identify a make, model, year, etc. of vehicle 1202; details (e.g., SKU, model number, etc.) of body panels 1210, 1212; and/or a status of doors 1206, 1208 and/or body panels 1210, 1212 (which may include or be associated with, for example, a type, extent, or location of damage thereto). In so doing, computing device 102 may tailor responses to the inquiry to that vehicle make/model/year, body panel model, ad/or door/panel status.

In some embodiments, computing device 102 may use the identified component characteristics to query one or more databases (e.g., sample database 106) for resources related to the subject vehicle component (e.g., “vehicle doors” in general) and/or one more identified vehicle characteristics (e.g., the model/year of vehicle 1202, the model of body panels 1210, 1212, the type of damage to body panels 1210, 1212, etc.). The resources may include, for example, installation guides, catalogues, repair manuals, and the like. Additionally or alternatively, computing device 102 queries one or more dynamic data sources other than a database of computer system 100, such as various Internet sources.

In the illustrated embodiment, AR interface 1200 includes an overlay 1220 generated by computing device 102 (e.g., in response to the inquiry). In this example, overlay 1220 includes a plurality of maintenance labels, including graphical labels 1222 as well as a text-based or instructional label 1224 (which may also be referred to generally as an instructional overlay or instructional panel). For example, graphical labels 1222 identify areas of interest relative to the depicted vehicle component 1204 – in this instance, areas of damage, which may include a larger or general area of damage as well as a localized area of more severe damage. In the illustrated embodiment, instructional label 1224 instructs a user (e.g., a viewer) of one or more remedial actions to be taken relative to the depicted vehicle component 1204 (e.g., “REPLACE BODY PANELS,” “CHECK DOOR LATCH FUNCTION”) as determined or identified by computing device 102. In some embodiments, overlay 1220 may additionally or alternatively include various details or data elements that computing device 102 has identified (and/or that have been provided to computing device 102 as part of the inquiry), including the subject vehicle component (“VEHICLE DOOR”), a status thereof (“DENTED”), and the like.

Overlay 1220 also includes display instructions defining the relative location of labels 1222, 1224 relative to the background (i.e., the live, real-time image or video stream). For instance, labels 1222 may be defined to be displayed relative to the actual areas of damage being depicted. Instructional label 1224, by contrast, may be defined to be displayed in a location that does not visually obstruct the areas of interest.

The locations of the various elements of overlay 1220 may be continually refreshed (e.g., a location and/or angle of the camera changes with respect to the location of vehicle 1202) so that the locations of the various elements of overlay 1220 remain corresponding to the actual locations of the applicable elements of vehicle 1202.

With reference now to FIG. 13, the depicted AR interface 1300 may be similar to AR interface 600, AR interface 1000, and/or AR interface 1200, in that AR interface 1300 may be generated by, for example, computing device 102 and displayed by, for example, an AR/VR headset 110 and/or a user computing device 108. In this example, AR interface 1300 may be an AR representation of a maintenance targeting related to vehicles, such as the maintenance and/or repair of vehicle components within an engine bay.

The user may access a mobile app using headset 110 and/or user computing device 108. The user may then input an inquiry related to maintenance or repair of vehicles. The inquiry may include, for example, search terms (“vehicle battery” or “oil change”), natural language text and/or speech (“This vehicle needs an oil change. What should I do first?”), selection from a menu of options, or other inputs that convey that the user wishes to review and/or perform one or more remedial actions related to repair or maintenance of a vehicle. For instance, in some embodiments, the user may access the mobile app and initiate capturing real-time image or video data of the vehicle using, for example, a camera of headset 110, and the system (e.g., computing device 102) may use various image processing functionality to identify that there is a subject vehicle component within the real-time image/video stream, and, in some further instances, that the subject vehicle component is one or more internal components of a vehicle (e.g., an engine, a battery, an oil dipstick, etc.). The system (e.g., computing device 102) may process a user inquiry (which may include the above-described real-time image/video stream) and generate AR interface 1300 in response thereto.

The generated AR interface 1300 may be displayed by headset 110 and/or user computing device 108. AR interface 1300 may include a background, which may include photographic imagery captured by, for example, the camera of headset 110 and/or user computing device 108. This photographic imagery may be continually updated in real time (e.g., by periodically or continuously capturing new images/video with the camera) so that AR interface 1300 represents a present view of or within, for example, vehicle 1202 (also shown in FIG. 12), and/or of a subject vehicle component 1302, which may include, in this example, one or more components within an engine bay of vehicle 1202. Alternatively, the background may be a virtual representation of vehicle 1202 and/or vehicle component 1302, rather than a live image/video.

In the exemplary embodiment, as described above, computing device 102 may be configured to identify a subject component (e.g., subject vehicle component 1302) depicted in a real-time image/video stream, and/or in one or more images or videos that may have been previously captured and provided to computing device 102 as part of the inquiry. In this example case, computing device 102 may identify a depicted vehicle component 1302 as a battery 1304, an oil dipstick 1306, a power steering fluid reservoir 1308, etc. (e.g., using image/video processing functionality, which may include artificial intelligence (AI) and/or machine learning (ML) techniques).

Moreover, computing device 102 may further identify one or more characteristics of the vehicle component (e.g., using image/video processing functionality, which may include artificial intelligence (AI) and/or machine learning (ML) techniques). In the example case, computing device 102 may be configured to identify a make, model, year, etc. of vehicle 1202, and, based thereon, may retrieve, access, or determine the vehicle components present within the engine bay, their relative location, and, in some instance, their brands and/or models. In so doing, computing device 102 may tailor responses to the inquiry to that vehicle make/model/year and those particular vehicle components 1302.

In some embodiments, computing device 102 may use the identified components, and/or characteristics thereof, to query one or more databases (e.g., sample database 106) for resources related to vehicle 1202, one or more subject vehicle components 1302, and/or one more identified vehicle characteristics. The resources may include, for example, training documents, catalogues, repair manuals, and the like. Additionally or alternatively, computing device 102 queries one or more dynamic data sources other than a database of computer system 100, such as various Internet sources.

In the illustrated embodiment, AR interface 1300 includes an overlay 1310 generated by computing device 102 (e.g., in response to the inquiry). In this example, overlay 1320 includes a plurality of maintenance labels, including graphical labels 1312. For example, graphical labels 1312 identify areas of interest relative to the depicted vehicle 1202 and/or vehicle component(s) 1302 – in this instance, areas of interest relative to a maintenance task, such as an oil change. In some embodiments, overlay 1310 may further include text-based or instructional labels, which may be identify the vehicle components 1302 highlighted by graphical labels, or may instruct a user (e.g., a viewer) of one or more remedial actions to be taken relative to the depicted vehicle component(s) 1302, as determined or identified by computing device 102. In some embodiments, overlay 1310 may additionally or alternatively include various details or data elements that computing device 102 has identified (and/or that have been provided to computing device 102 as part of the inquiry), including a subject vehicle component, a status thereof, and the like.

Overlay 1310 may also include display instructions defining the relative location of labels 1312 relative to the background (i.e., the live, real-time image or video stream). For instance, labels 1312 may be defined to be displayed relative to the actual components they are functioning to identify or highlight. The locations of the various elements of overlay 1310 may be continually refreshed (e.g., a location and/or angle of the camera changes with respect to the location of vehicle 1202) so that the locations of the various elements of overlay 1310 remain corresponding to the actual locations of the applicable elements of vehicle 1202.

### Exemplary Virtual Reality Interfaces

FIG. 7 depicts an exemplary VR interface 700. VR interface 700 may be generated by, for example, computing device 102 and displayed by, for example, user computing device 108 and/or an AR or VR headset (e.g., headset 110; all shown in FIG. 1).

The user may access a mobile app using user computing device 108 and/or headset 110. The user may then input an inquiry related to, for the purposes of illustration, a leak in their kitchen sink. The inquiry may include, for example, search terms (“sink leak water”), natural language text and/or speech (“My sink is leaking into the cabinet below. What can I do?”), selection from a menu of options, or other inputs that convey that the user wishes to review and/or perform one or more remedial actions related to the sink and/or a related system (e.g., a water supply system, a drainage system, etc.). The system (e.g., computing device 102) may process this inquiry and generate VR interface 700 in response thereto.

The generated VR interface 700 may be displayed by user computing device 108 and/or headset 110 via the mobile app. VR interface 700 may include a background, which may include one or more VR representations of a building and/or the subject building component identified in the inquiry. In this example case, the background may include a VR representation of a home including a kitchen in which the subject building component, including a kitchen sink, is depicted.

Additionally, VR interface 700 includes a virtual representation of the maintenance targeting presented by computing device 102. For example, VR interface 700 may include an instruction, description, or other identification of one or more interventions proposed to address the inquiry. VR interface 700 may further include an avatar performing the interventions in accordance with the guidance, in a first-person or third-person view, such that VR interface 700 enables a user of user computing device 108 to review the maintenance targeting and its steps or actions before initiating the maintenance targeting themselves.

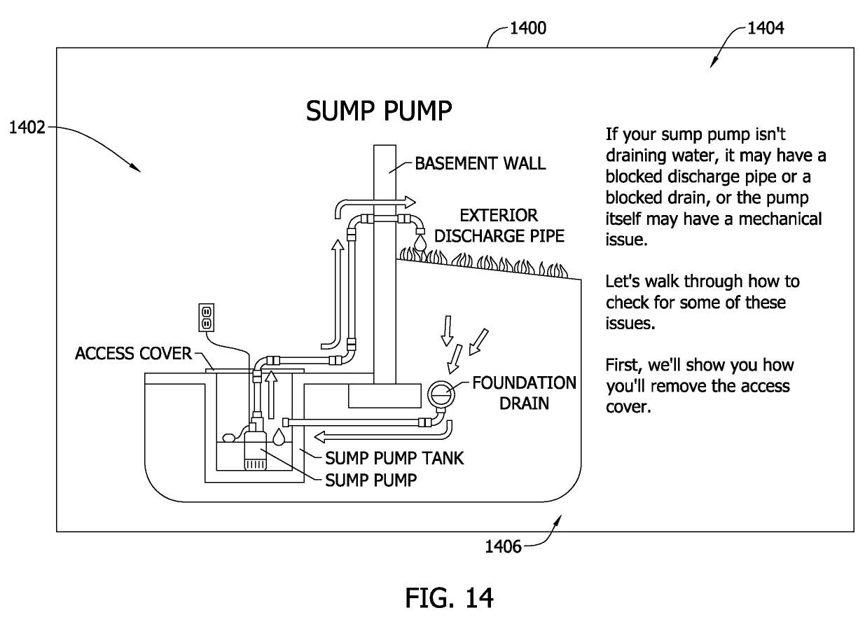

FIGS. 14-16 depict another exemplary VR interface 1400. VR interface 1400 may be generated by, for example, computing device 102 and displayed by, for example, a user computing device 108 and/or an AR or VR headset (e.g., headset 110; all shown in FIG. 1). In some instances, VR interface 1400 may be contextually related to AR interface 600 and/or AR interface 1000, and may be requested, generated, and/or displayed before AR interface 600 and/or interface 1000. That is, in this example, VR interface 1400 may include a VR representation of the maintenance targeting discussed with respect to FIGS. 5A-5C, 6, and 10 (i.e., the inspection of a sump pump).

The user may access a mobile app using their user computing device 108 and/or headset 110. The user may then input an inquiry related to, for the purposes of illustration, an issue with their sump pump. The inquiry may include, for example, search terms (“sump pump basement”), natural language text and/or speech (“There is water around my sump pump. What can I do to fix it?”), selection from a menu of options, or other inputs that convey that the user wishes to review and/or perform one or more remedial actions related to operation of the sump pump. The system (e.g., computing device 102) may process this inquiry and generate VR interface 1400 in response thereto.

The generated VR interface 1400 may be displayed by user computing device 108 and/or headset 110 via the mobile app. VR interface 1400 may include a background, which may include one or more VR representations of a building and/or the subject building component identified in the inquiry. In this example case, the background may include a VR representation of building 114 (also shown in FIG. 1) in which a subject building component 120 is depicted. In this example case, the background may include a virtual representation 1402 of a subject building component including sump pump assembly 602 (also shown in FIG. 6)

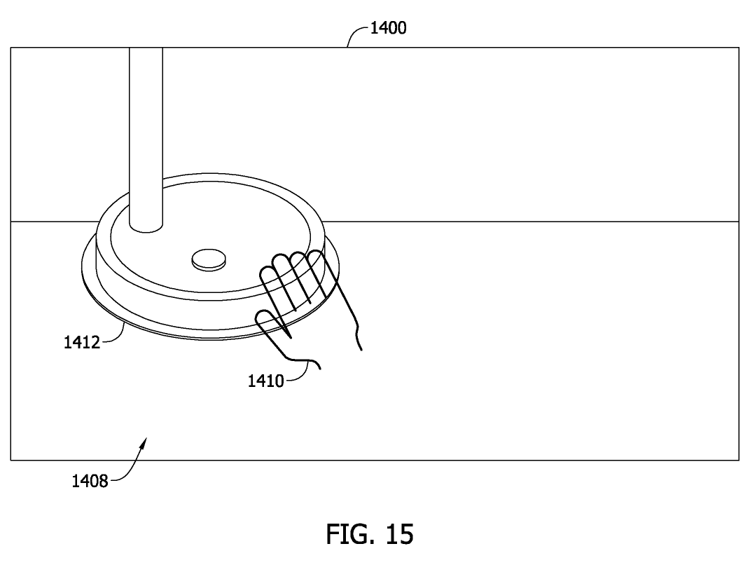

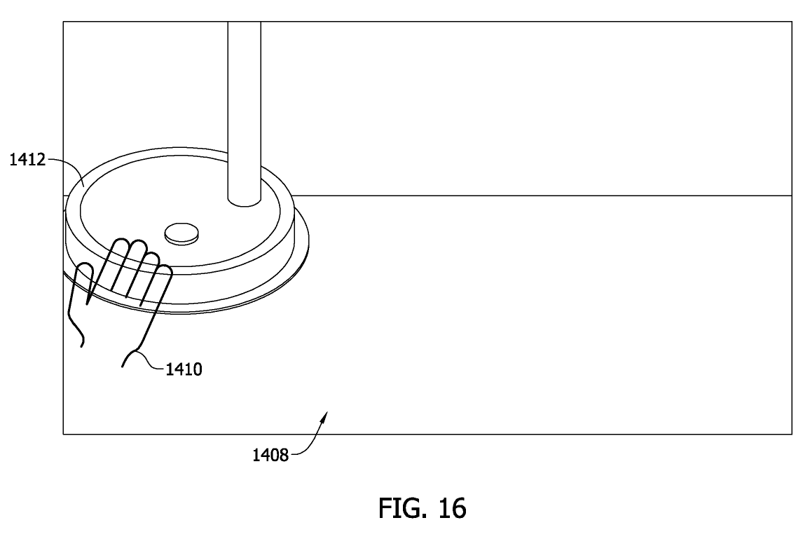

Additionally, VR interface 1400 includes a virtual representation 1404 of the maintenance targeting presented by computing device 102. For example, as shown in FIG. 14, VR interface 1400 may include a first screen or “scene” 1406 that depicts an instruction, description, or other identification of one or more interventions proposed to address the inquiry. VR interface 1400 may also include a second screen or scene 1408, shown in FIGS. 15 and 16, in which an avatar, in a first-person or third-person view, is shown completing an action described in the first scene (e.g., a set of instructions or description of the action). In the present example, the second scene 1408 depicts an avatar’s virtual hand 1410 manipulating a virtual representation of an access cover 1412 of sump pump assembly 602. The second scene 1408 may include an animation or in-motion virtual representation of the avatar hand 1410 performing the function. Additionally or alternatively, the second scene 1408 may include one or more graphical indicators or icons (e.g., an arrow pointing in a direction of motion) and/or textual information further describing the action(s) being depicted. Therefore, VR interface 1400 enables a user of user computing device 108 to review the maintenance targeting and its steps or actions before initiating the maintenance targeting themselves.

As described elsewhere herein, VR interface 1400 may be generated using AI techniques, in part or in whole, such that partial or full customization of VR interface 1400 relative to the user’s own home or building component(s) may be realized.

### Exemplary Method for Generating a Maintenance Target for a Building Component of a Building

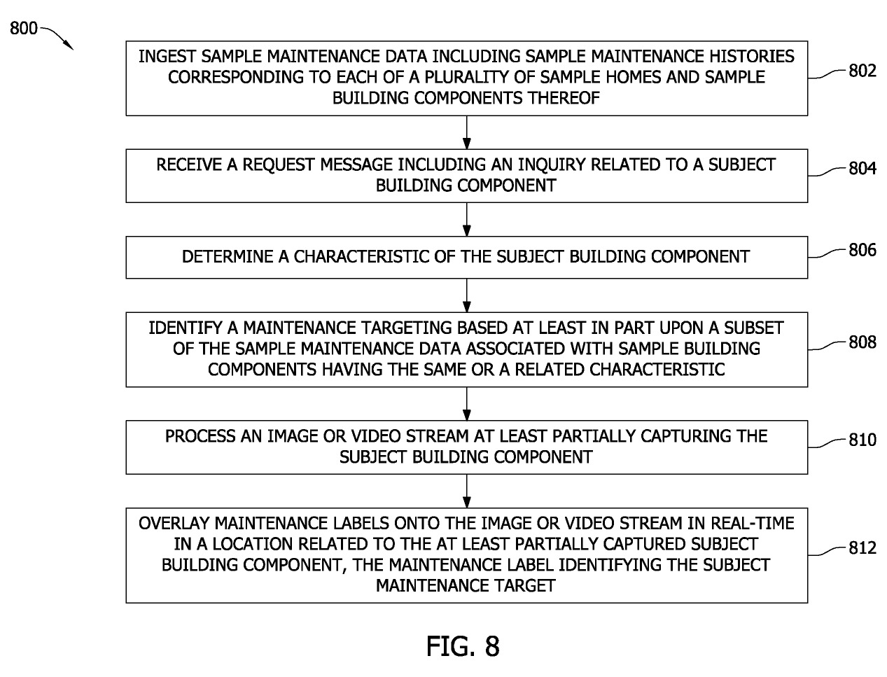

FIG. 8 depicts a flow chart of an exemplary computer-implemented method 800 for generating a maintenance target for a building component of a building, for overlay on a real-time incoming visual data stream from a user computing device. One or more actions or steps of computer-implemented method 800 may be performed using maintenance targeting generator and model feedback computing system 100 (shown in FIG. 1).

In the exemplary embodiment, computer-implemented method 800 may include ingesting 802 sample maintenance data for a plurality of sample homes, the sample maintenance data including sample maintenance histories corresponding to each of the plurality of sample homes and sample building components thereof. Computer-implemented method 800 may also include receiving 804, from a user computing device (e.g., user computing device 108), a request message including an inquiry related to a subject building component.

Computer-implemented method 800 may further include determining 806 a characteristic of the subject building component and identifying 808 a subject maintenance targeting based at least in part upon a subset of the sample maintenance data associated with sample building components having the same or a related characteristic.

In the exemplary embodiment, computer-implemented method 800 may also include processing 810 an image or video stream captured at the user computing device, the image or video stream at least partially capturing the subject building component, and overlaying 812 one or more maintenance labels onto the image or video stream in real-time in a location related to the at least partially captured subject building component, the maintenance label identifying the subject maintenance target.

Computer-implemented method 800 may include additional, fewer, or alternative steps, including those discussed elsewhere herein.

In some embodiments, determining 806 may include receiving the characteristic within the request message and parsing the characteristic from the request message. In other embodiments, determining 806 may include deriving the characteristic from data contained within the request message.

In some embodiments, the subject maintenance targeting is associated with a part of the subject building component, and computer-implemented method 800 may include generating the overlay including a text-based maintenance label identifying the part of the subject building component and at least one graphical maintenance label of the subject building component. In some such embodiments, overlaying 812 may include overlaying the graphical maintenance label in a location of the image or video stream related to the part of the subject building component and the text-based maintenance label in a location within the image or video stream that is contextually near to the graphical maintenance label and does not overlap with the part of the subject building component. In some further embodiments, computer-implemented method 800 may include generating the overlay further including one or more other text-based maintenance labels identifying a corresponding one or more other parts of the subject building component, and overlaying 812 may include overlaying the one or more other text-based maintenance labels in a corresponding one or more other locations within the image or video stream related to the corresponding one or more other parts of the subject building component.

In some embodiments, the subject maintenance targeting includes an intervention to be performed that is related to the subject building component, and computer-implemented method 800 may include generating the overlay including a graphical maintenance label conveying the intervention. In some such embodiments, overlaying 812 may include overlaying the graphical maintenance label in a location within the image or video stream related to performance of the intervention.

In some embodiments, computer-implemented method 800 may include generating a user interface including an access to a chatbot for display at the user computing device. In some such embodiments, receiving 804 may include receiving the request message as an input to the chatbot. In some further embodiments, computer-implemented method 800 may include, upon identifying a subject maintenance targeting, displaying the access to the chatbot including a response message, the response message including a prompt for a user of the user computing device to select a presentation format for the subject maintenance targeting, and generating the overlay in response to a user selection of an augmented reality presentation format. In some instances, computer-implemented method 800 may include generating a natural language text-based message in response to a user selection of a text-based presentation format, the text-based message including instructions related to the subject maintenance targeting. In some other embodiments, computer-implemented method 800 may include generating a virtual reality representation of the subject building component and the subject maintenance targeting in response to a user selection of a virtual reality presentation format.

In some embodiments, identifying 808 may include executing a trained machine-learning model trained on the sample maintenance data as an initial training data set. In some such embodiments, computer-implemented method 800 may include receiving user feedback associated with at least one of: (i) efficacy of the subject maintenance targeting, and (ii) a presentation format of the subject maintenance targeting, and retrain the train machine-learning model based upon the user feedback.

In some embodiments, identifying 808 may include generating one or more database queries for filtering the sample maintenance data to the subset of the sample maintenance data. In some such embodiments, computer-implemented method 800 may include querying at least one database using the one or more database queries to retrieve the filtered subset of the sample maintenance data for further processing.

In some embodiments, computer-implemented method 800 may include generating a user interface including a prompt for the request message and causing display of the user interface within a mobile application executed on the remote computing device.

In some embodiments, computer-implemented method 800 may include receiving user feedback indicating the subject maintenance targeting was not successfully responsive to the inquiry, and identifying a second subject maintenance targeting to present to the user in response to the inquiry.

### Exemplary Computer-Implemented Method for Incorporating Feeback for Re-Training Model

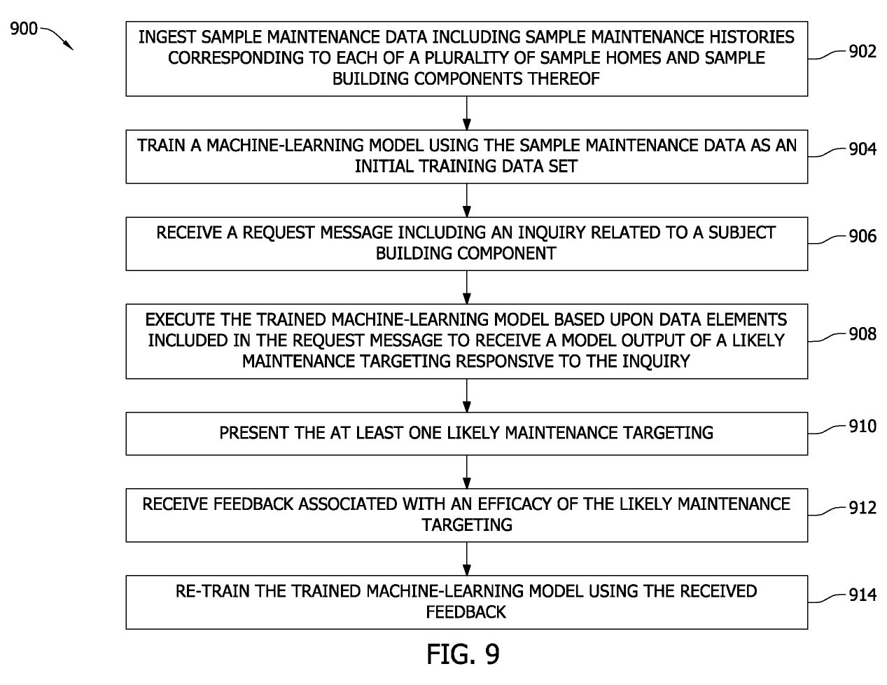

FIG. 9 depicts a flow chart of an exemplary computer-implemented method 900 for incorporating feedback associated with maintenance target output formatting and efficacy for re-training at least one machine-learned model. One or more actions or steps of computer-implemented method 900 may be performed using maintenance target generator and model feedback computing system 100 (shown in FIG. 1).

In the exemplary embodiment, computer-implemented method 900 may include ingesting 902 sample maintenance data for a plurality of sample homes, the sample maintenance data including sample maintenance histories corresponding to each of the plurality of sample homes and sample building components thereof. Computer-implemented method 900 may also include training 904 a machine-learning model using the sample maintenance data as an initial training data set, and receiving 906, from a user computing device (e.g., user computing device 108), a request message including an inquiry related to a subject building component.

Computer-implemented method 900 may further include executing 908 the trained machine-learning model based upon one or more data elements included in the request message to receive a model output of at least one likely maintenance targeting responsive to the inquiry. In the exemplary embodiment, computer-implemented method 900 may also include presenting 910 the at least one likely maintenance targeting, receiving 912 feedback, from the user computing device, associated with an efficacy of the at least one likely maintenance targeting, and re-training 914 the trained machine-learning model using the received feedback

Computer-implemented method 900 may include additional, fewer, or alternative steps, including those discussed elsewhere herein.

In some embodiments, the model output may include a second likely maintenance targeting responsive to the inquiry, and the feedback may indicate a failure of the at least one likely maintenance targeting. In some instances, computer-implemented method 900 may include presenting the second likely maintenance targeting, receiving second feedback indicating success of the second likely maintenance targeting, and furthering re-train the trained machine-learning model using the received second feedback.

In some such embodiments, computer-implemented method 900 may also include receiving, from a second user computing device, a second request message including a second inquiry related to a second subject building component having at least one characteristic in common with the subject building component. Computer-implemented method 900 may still further include executing the re-trained machine-learning model based upon one or more data elements included in the second request message to receive a model output of the second likely maintenance targeting, and presenting the second likely maintenance targeting.

In other such embodiments, computer-implemented method 900 may also include using the model output from the re-trained machine-learning model to generate a database query, and querying an active user database using the database query. Computer-implemented method 900 may still further include, based upon a response to the database query, identifying a second subject building component, the second subject building component having at least one characteristic in common with the subject building component, and transmitting, to a second user computing device, a recommendation message including the second likely maintenance targeting

In some instances, receiving 906 may include receiving the request message in a natural language text-based format.

In some cases, presenting 910 may include generating a response message including the at least one likely maintenance targeting in the natural language text-based format, and causing display of the response message within a user interface on the user computing device.

In some embodiments, presenting 910 may include generating an overlay of a real-time image or video stream captured at the user computing device in response to a user selection of an augmented reality response format, and causing display of the overlay on the real-time image or video stream within a user interface on the user computing device.

In some embodiments, presenting 910 may include generating a virtual reality representation of the subject building component and the at least one likely maintenance targeting in response to a user selection of a virtual reality display format, and causing display of the virtual reality representation within a user interface on the user computing device.

In some embodiments, computer-implemented method 900 may include generating a user interface including a prompt for the request message and causing display of the user interface within a mobile application executed on the remote computing device.

In some embodiments, computer-implemented method 900 may include generating a user interface including an access to a chatbot for display at the user computing device, and receiving the request message as an input to the chatbot.

In some cases, computer-implemented method 900 may also include deriving at least one characteristic of the subject building component from data contained within the request message

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

### Machine Learning and Other Matters

In some embodiments, maintenance target generator 102 is configured to implement machine learning, such that maintenance target generator 102 “learns” to analyze, organize, and/or process data without being explicitly programmed. Machine learning may be implemented through machine learning methods and algorithms (“ML methods and algorithms”). In an exemplary embodiment, maintenance target generator 102 and/or is otherwise in communication with a machine learning module (“ML module”) that is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, characteristics, item classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample building and building component data with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

Based upon these analyses, the processing element may learn how to identify characteristics and patterns that may then be applied to analyzing input data related to subject building components and generating output data related to likely maintenance targets therefor. The processing element may also learn how to identify attributes or characteristics of building components.

In some embodiments, the chatbots discussed herein may be configured to utilize AI and/or ML techniques. For instance, the chatbot may be a GPT-based chatbot. The chatbot may employ supervised or unsupervised machine learning techniques, which may be followed by and/or used in conjunction with reinforced or reinforcement learning techniques. The chatbot may employ the techniques utilized for ChatGPT. The voice bot or chatbot may deliver various types of output for user consumption in certain embodiments, such as verbal or audible output, a dialogue output, text or textual output (such text or graphics presented on a computer or mobile device screen or display), visual or graphical output, and/or other types of outputs.

For the purposes of this discussion, a chatbot is a software application used to conduct an online chat conversation via text or text-to-speech, in lieu of providing direct contact with a live human agent. Chatbots are computer programs that are capable of maintaining a conversation with a user in natural language, understanding their intent, and replying based upon preset rules and data.

ChatGPT is an artificial intelligence chatbot. It is built on a family of large language models and has been fine-tuned (an approach to transfer learning) using both supervised and reinforcement learning techniques. ChatGPT is a member of the generative pre-trained transformer (GPT) family of language models. It was fine-tuned (an approach to transfer learning) over previous versions. The fine-tuning process leveraged both supervised learning as well as reinforcement learning in a process called reinforcement learning from human feedback (RLHF). Both approaches used human trainers to improve the model's performance. In the case of supervised learning, the model was provided with conversations in which the trainers played both sides: the user and the AI assistant. In the reinforcement learning step, human trainers first ranked responses that the model had created in a previous conversation. These rankings were used to create 'reward models' that the model was further fine-tuned on using several iterations of Proximal Policy Optimization (PPO). Proximal Policy Optimization algorithms present a cost-effective benefit to trust region policy optimization algorithms; they negate many of the computationally expensive operations with faster performance. In addition, chatbots similar to and including ChatGPT continue to gather data from users that could be used to further train and fine-tune the chatbot. Users can upvote or downvote responses they receive from ChatGPT and fill out a text field with additional feedback.

### Additional Considerations

Described herein are computer systems such as the computer devices and related computer systems forming the work estimation computer system. As described herein, all such computer systems include a processor and a memory. However, any processor in a computer device referred to herein can also refer to one or more processors wherein the processor can be in one computing device or a plurality of computing devices acting in parallel. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS’ include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

Disjunctive language such as the phrase “at least one of X, Y, or Z,” unless specifically stated otherwise, is generally understood within the context as used to state that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A maintenance target generator for targeted component repair or maintenance instruction, the maintenance target generator comprising at least one processor in communication with at least one memory device, the at least one processor configured to:
ingest sample maintenance data for a plurality of sample homes, the sample maintenance data including maintenance histories corresponding to each of the plurality of sample homes and building components thereof;
receive, from a user computing device, a request message including an inquiry related to a subject building component;
determine a characteristic of the subject building component;
identify a subject maintenance target based at least in part a subset of the sample maintenance data associated with building components having the same or a related characteristic;
process an image or video stream captured at the user computing device, the image or video stream at least partially capturing the subject building component; and
overlay one or more maintenance labels onto the image or video stream in real-time in a location related to the at least partially captured subject building component, the maintenance label identifying the subject maintenance target.

2. The maintenance target generator of claim 1, wherein to determine the characteristic of the subject building component, the at least one processor is configured to receive the characteristic within the request message.

3. The maintenance target generator of claim 1, wherein to determine the characteristic of the subject building component, the at least one processor is configured to derive the characteristic from data contained within the request message.

4. The maintenance target generator of claim 1, wherein the subject maintenance target is associated with a part of the subject building component.

5. The maintenance target generator of claim 4, wherein the at least one processor is further configured to:
generate the overlay including a text-based maintenance label identifying the part of the subject building component and at least one graphical maintenance label of the subject building component, and
wherein to overlay the one or more maintenance labels, the at least one processor is further configured to overlay the graphical maintenance label in a location of the image or video stream related to the part of the subject building component and the text-based maintenance label in a location of the image or video stream that is contextually near to the graphical maintenance label and does not overlap the part of the subject building component.

6. The maintenance target generator of claim 5, wherein the at least one processor is further configured to:
generate the overlay further including one or more other text-based maintenance labels identifying a corresponding one or more other parts of the subject building component, and
wherein to overlay the one or more maintenance labels, the at least one processor is further configured to overlay one or more other text-based maintenance labels in a corresponding one or more other locations of the image or video stream related to the corresponding one or more other parts of the subject building component.

7. The maintenance target generator of claim 6, wherein the one or more other text-based labels do not overlap the text-based maintenance label identifying the part of the subject building component.

8. The maintenance target generator of claim 4, wherein the subject maintenance target includes an intervention to be performed that is related to the part of the subject building component.

9. The maintenance target generator of claim 8, wherein the at least one processor is further configured to:
generate the overlay including a graphical maintenance label conveying the intervention, and
wherein to overlay the one or more maintenance labels, the at least one processor is further configured to overlay the graphical maintenance label in a location of the image or video stream related to performance of the intervention.

10. The maintenance target generator of claim 1, wherein the subject maintenance target includes an intervention to be performed that is related to the subject building component.

11. The maintenance target generator of claim 10, wherein the at least one processor is further configured to:
generate the overlay including a graphical maintenance label conveying the intervention, and
wherein to overlay the one or more maintenance labels, the at least one processor is further configured to overlay the graphical maintenance label in a location of the image or video stream related to performance of the intervention.

12. The maintenance target generator of claim 1, wherein the at least one processor is further configured to:
generate a user interface including a chatbot for display at the user computing device; and
receive the request message as an input to the chatbot.

13. The maintenance target generator of claim 12, wherein the at least one processor is further configured to:
upon identifying a subject maintenance target, display the chatbot including a response message, the response message including a prompt for a user of the user computing device to select a display format for the subject maintenance target; and
generate the overlay in response to a user selection of an augmented reality display format.

14. The maintenance target generator of claim 13, wherein the at least one processor is further configured to:
generate a natural language text-based message in response to a user selection of a text-based display format, the text-based message including instructions related to the subject maintenance target; and/or
generate a virtual reality representation of the subject building component and the subject maintenance target in response to a user selection of a virtual reality display format.

15. The maintenance target generator of claim 1, wherein the at least one processor is further configured to identify a subject maintenance target by executing a trained machine-learning model trained on the sample maintenance data as an initial training data set.

16. The maintenance target generator of claim 15, wherein the at least one processor is further configured to:
receive user feedback associated with at least one of: (i) efficacy of the subject maintenance target, and (ii) a display format of the subject maintenance target; and
retrain the train machine-learning model based upon the user feedback.

17. The maintenance target generator of claim 1, wherein to identify the subject maintenance target, the at least one processor is further configured to:
generate one or more database queries for filtering the sample maintenance data to the subset of the sample maintenance data; and
query at least one database using the one or more database queries to retrieve the filtered subset of the sample maintenance data for further processing.

18. The maintenance target generator of claim 1, wherein the at least one processor is further configured to:
generate a user interface including a prompt for the request message; and
cause display of the user interface within a mobile application executed on the user computing device.

19. The maintenance target generator of claim 1, wherein the at least one processor is further configured to:
receive user feedback indicating the subject maintenance target was not successfully responsive to the inquiry; and
identify a second subject maintenance target to present to the user in response to the inquiry.

20. A computer-implemented method for targeted component repair or maintenance instruction, the method implemented using at least one maintenance target generator including at least one processor in communication with at least one memory device, the method comprising:
ingesting sample maintenance data for a plurality of sample homes, the sample maintenance data including maintenance histories corresponding to each of the plurality of sample homes and building components thereof;
receiving, from a user computing device, a request message including an inquiry related to a subject building component;
determining a characteristic of the subject building component;
identifying a subject maintenance target based at least in part a subset of the sample maintenance data associated with building components having the same or a related characteristic;
processing an image or video stream captured at the user computing device, the image or video stream at least partially capturing the subject building component; and
overlaying one or more maintenance labels onto the image or video stream in real-time in a location related to the at least partially captured subject building component, the maintenance label identifying the subject maintenance target.
